(19) United States
(12) Patent Application Publication
(10) Pub. No.: US 2015/0360737 A1
(43) Pub. Date: Dec. 17, 2015

(54) VEHICLE GLASS REMOVAL AND REPLACEMENT SYSTEM AND METHOD

(71) Applicants: Richard E. Brummett, Tremont, IL (US); Douglas A. Rasmussen, Washington, IL (US)

(72) Inventors: Richard E. Brummett, Tremont, IL (US); Douglas A. Rasmussen, Washington, IL (US)

(21) Appl. No.: 14/640,116

(22) Filed: Mar. 6, 2015

Related U.S. Application Data
(60) Provisional application No. 62/011,352, filed on Jun. 12, 2014.

(51) Int. Cl. B62D 65/02; B66D 1/60; B66C 19/00; B62D 65/06

(52) U.S. Cl. CPC B62D 65/022; B62D 65/06; B66D 1/60; B66C 19/00

(57) ABSTRACT

A lift armature for lifting a windshield when removing the windshield from or replacing the windshield in a vehicle, includes an armature frame, multiple lifting devices, and at least one hoisting device. The multiple lifting devices are pivotally connected to the armature frame and configured to detachably connect to the surface of the windshield. The at least one hoisting device is pivotally connected to the armature frame.

### PRIORITY

This application claims priority to and incorporates by reference, U.S. Provisional Patent Application No. 62/011352, entitled “Windshield Removal and Replacement System and Method”, and filed Jun. 12, 2014.

### TECHNICAL FIELD

The present invention generally relates to vehicle servicing. More particularly, the present invention relates to a system and method for the removal and replacement of vehicle glass.

### BACKGROUND OF THE INVENTION

Windshields are an integral component of all automobiles and many other vehicles. Common weights for windshield glass range from approximately 30 pounds in a personal consumer vehicle to nearly 100 pounds in a large truck or commercial vehicle. The design of modern automobiles incorporates the windshield as a key source of structural integrity, being particularly relevant in preventing vehicle roof collapse in the event of a rollover crash. Sunroofs may also be designed as a structural element in some vehicles.

The removal and replacement of windshield glass and other large panels of glass in vehicles presents challenges due to the difficulty of both safely elevating and transporting heavy pieces of glass, and precisely positioning and installing replacement glass while establishing a seal and maintaining structural integrity in accordance with the vehicle's design. Inherent risks exist both for service personnel, as only a very small percentage of the adult population is estimated to possess sufficient upper-body strength to lift and position weights in this order of magnitude, as well as the vehicle itself, which can easily be damaged by impact from such a weight.

In the automotive glass industry, established processes for vehicle windshield replacement generally employ two installers working in tandem, or employ only one installer working with or without assistive devices. Assistive devices currently in use by windshield installers generally consist of apparatuses such as handles and levers for attachment to a windshield. The application of such assistive devices is limited to facilitating the manual lifting and handling of the windshield glass, and they are used in processes that still require significant physical exertion as well as extensive manual examination and measurements to ensure the safe handling of glass and the precise positioning of the replacement windshield or other glass panel.

### SUMMARY OF THE INVENTION

In one aspect of the present invention, a lift armature for lifting a windshield when removing the windshield from or replacing the windshield in a vehicle, includes an armature frame, multiple lifting devices, and at least one hoisting device. The multiple lifting devices are pivotally connected to the armature frame and configured to detachably connect to the surface of the windshield. The at least one hoisting device is pivotally connected to the armature frame.

In another aspect of the present invention, a vehicle windshield removal method includes attaching at least one lifting device of a lifting armature to the windshield while the windshield installed in the windshield frame of a vehicle; and connecting a hoisting system to one or more hoisting devices of the lifting armature. The method additionally includes detaching the windshield from the windshield frame; inputting a lift command with a user control device to generate a lift signal; providing power to the hoisting system with a power source in response to the lift signal; and lifting the windshield out of the windshield frame with the lifting armature and hoisting system.

In yet another aspect of the present invention, a vehicle windshield replacement method includes applying a urethane bead around the perimeter of an empty vehicle windshield frame; connecting at least one lifting device of a lifting armature to a new replacement windshield; connecting a hoisting system to one or more hoisting devices of the lifting armature; and inputting a lift command with an user control device to generate a lift signal. The method additionally includes providing power to the hoisting system with a power source in response to the lift signal; lifting the replacement windshield with the lifting armature and hoisting system; moving the replacement windshield over the windshield frame with the lifting armature and a positioning system; inputting a lower command with the user control device to generate a lower signal; providing power to the hoisting system with the power source in response to the lower signal; and lowering the replacement windshield into the windshield frame and onto the bead with the lifting armature and hoisting system.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a vehicle glass removal and replacement system;

FIG. 2 is a perspective view of an exemplary embodiment of a lifting armature;

FIG. 3A is a perspective view of a first exemplary embodiment of a control handle assembly and a first exemplary embodiment of an user control device;

FIG. 3B is a perspective view of a second exemplary embodiment of a control handle assembly and a second exemplary embodiment of an user control device;

FIG. 3C is an expanded view of a third exemplary embodiment of a control handle assembly and a third exemplary embodiment of an user control device;

FIG. 4A is a perspective view of a first exemplary embodiment of a mobile gantry;

FIG. 4B is another perspective view of the mobile gantry of FIG. 4A;

FIG. 4C is a cross section of the mobile gantry of FIG. 4A along the dotted line marked 4C.

FIG. 4D is a perspective view of a portion of the mobile gantry of FIG. 4A in circle 4D;

FIG. 4E is another perspective view of the mobile gantry of FIG. 4A;

FIG. 4F is a perspective view of a second exemplary embodiment of a mobile gantry;

FIG. 4G is another perspective view of the mobile gantry of FIG. 4F;

FIG. 4H is a perspective view of a portion of the mobile gantry of FIG. 4F in circle 4H;

FIG. 5 is a perspective view of an exemplary embodiment of a stationary gantry and trolley unit;

FIG. 6 is a perspective view of an exemplary embodiment of a trolley unit and an exemplary embodiment of a hoisting system for use with the stationary gantry of FIG. 5;

FIG. 7 is a perspective view of the trolley unit of FIG. 6;

FIG. 8 is another perspective view of the trolley unit of FIG. 6;

FIG. 9 is another perspective view of the trolley unit of FIG. 6;

FIG. 10A is a block diagram of an exemplary embodiment of a control system for use with the vehicle glass removal and replacement system of FIG. 1;

FIG. 10B is a block diagram of a second embodiment of a user control device.

FIG. 11 is a flow chart of an exemplary method to connect the lifting armature of FIG. 2 to a positioning system and a hoisting system;

FIG. 12A is a flow chart of a first portion of an exemplary method of removing a windshield from a vehicle;

FIG. 12B is a flow chart of a second portion of the method of removing a windshield from a vehicle of FIG. 12A;

FIG. 13 is a perspective view of the lifting armature of FIG. 2 connected to an exemplary embodiment of a windshield and an exemplary embodiment of cables a hoisting system;

FIG. 14A is a flow chart of a first portion of an exemplary method of replacing a windshield on a vehicle;

FIG. 14B is a flow chart of a second portion of the method of replacing a windshield on a vehicle of FIG. 14A; and

FIG. 15 is a perspective view of the system of FIG. 1 with the lifting armature connected to a windshield.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

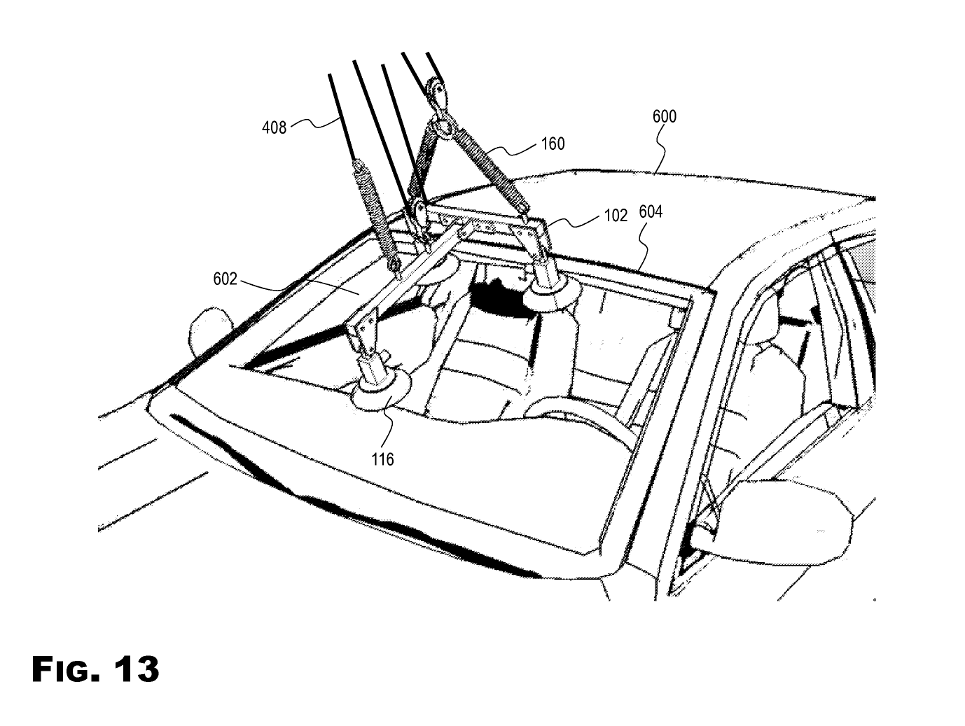

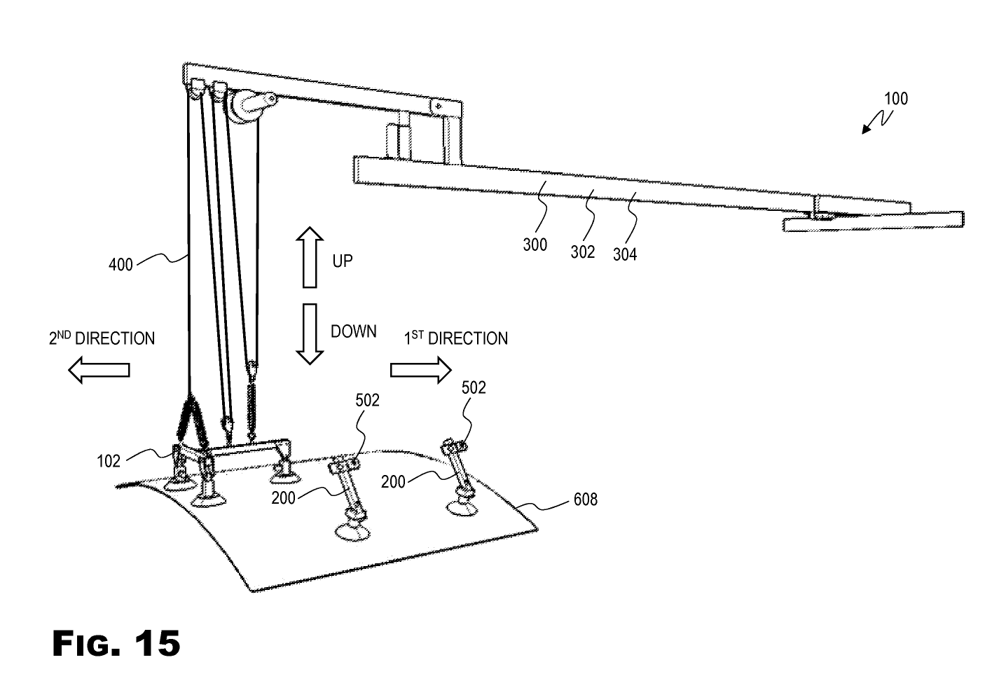

One or more of the embodiments of the present invention provide a windshield removal and replacement system 100 and methods for the use thereof. Embodiments of the present invention may be operated in conjunction with a subject vehicle 600 (shown and described in relation to FIG. 13) installed with a windshield (shown and described in relation to FIGS. 13 and 15). Throughout this description, positional terms such as “above,” “below,” “forward,” and “rear” refer to a perspective facing the front of a subject vehicle from the exterior of the subject vehicle. Therefore, for example, “rearwards” with respect to the invention is defined as an orientation towards the front of the subject vehicle. Throughout this description various relational terms such as: longitudinal, lateral, top, bottom, first, second, front, and back; may be used to describe elements or components in relation to other elements or components. These terms are not used in a manner to limit the invention, but rather to describe relationships between components.

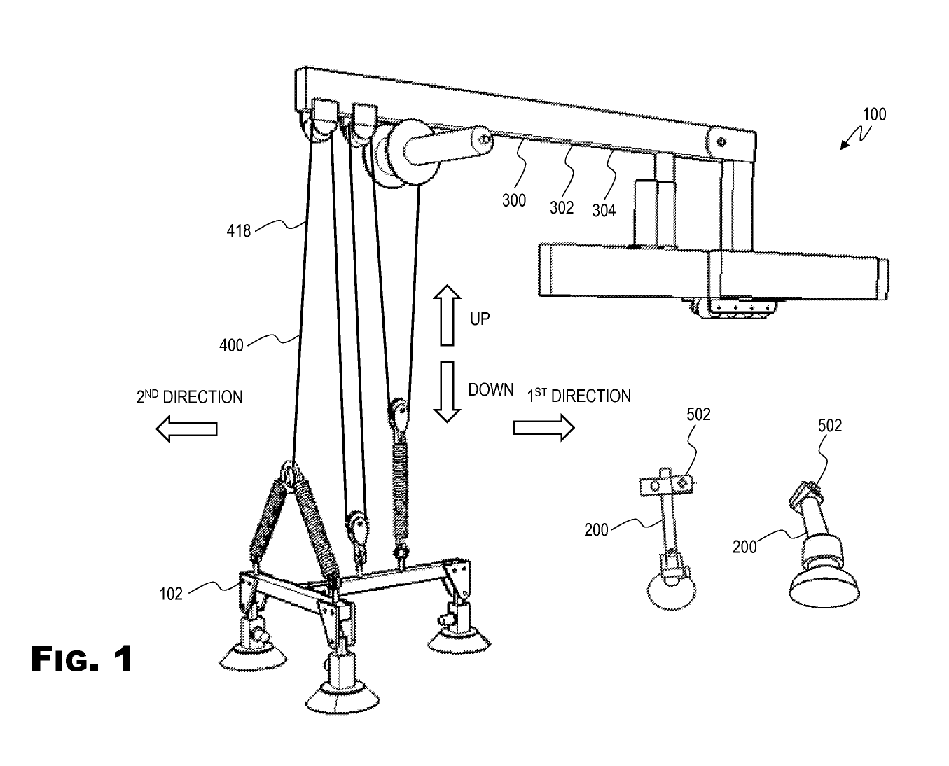

Referring now to FIG. 1 an exemplary embodiment of a windshield removal and replacement system 100 is illustrated in a perspective view. The system may include a lifting armature 102, a hoisting system 400, a positioning system 300, one or more control handle assemblies 200, and one or more user control devices 502. The hoisting system 400 may be configured to lift the lifting armature 102 in a generally upward direction represented by the arrow labeled “UP”. The hoisting system 400 may also be configured to lower the lifting armature 102 in a generally downward direction represented by the arrow labeled “DOWN”. The hoisting system 400 may include cables 418 which connect the lifting armature 102 with the hoisting system 400.

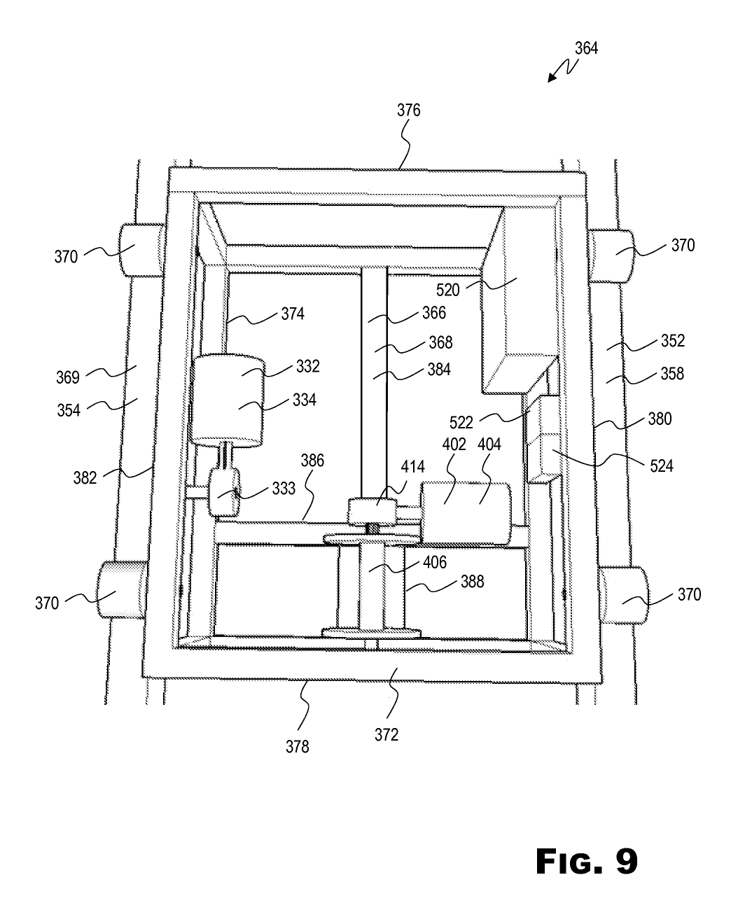

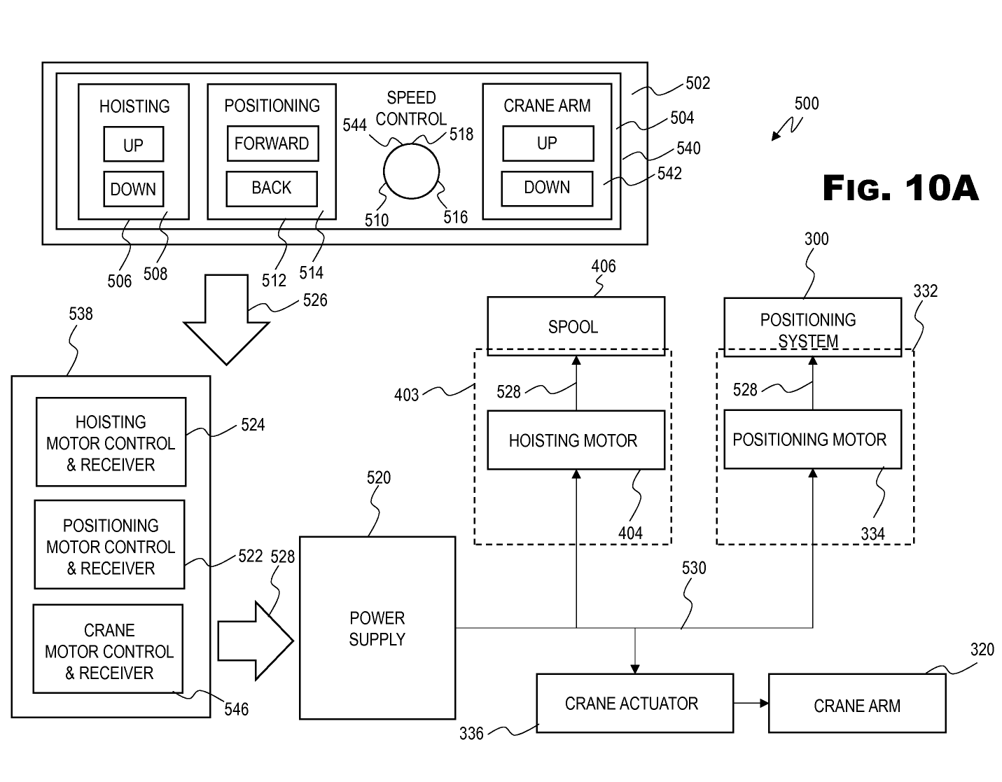

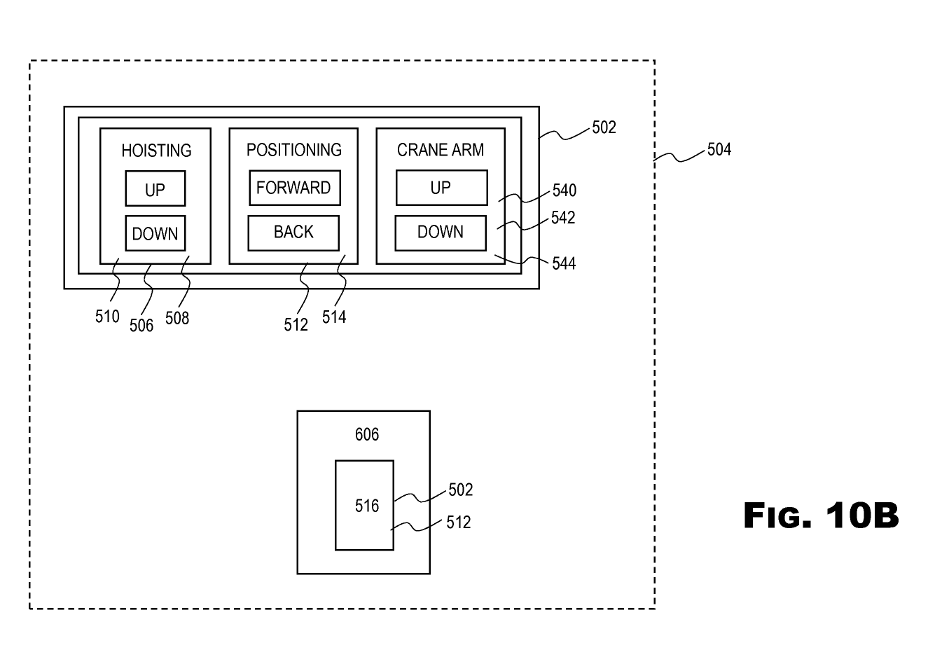

The positioning system 300 may be configured to move the lifting armature 102 in a generally first direction represented by the arrow labeled “1^{st} DIRECTION”. The positioning system 300 may also be configured to move the lifting armature 102 in a generally second direction represented by the arrow labeled “2^{nd} DIRECTION”. The positioning system 300 may include a gantry 302. For the purposes of this application, the gantry 302 may include any structure for supporting the hoisting system 400 and the lifting armature 102. In the illustrated embodiment, the gantry 302 includes a mobile gantry 304. The mobile gantry 304 may be configured for connection to a service vehicle 606 (shown schematically in relation to FIG. 10B), such as for example a van, making the system 100 mobile and able to service vehicles 600 at multiple locations. In other embodiments, the gantry 300 may be a stationary gantry 306 (illustrated and described in relation to FIGS. 9-13). The stationary gantry 306 may be configured to be installed in a building or at a work site such as a garage or vehicle service station or building. Part or all of the hoisting system 400 may be fixedly mounted on the gantry 302 such that the gantry 302 supports the hoisting system 400 and the lifting armature 102.

The lifting armature 102 and the one or more control handle assemblies 200 may be configured to detachably connect to the windshield 602 to lift, lower, and move the windshield 602 for removal from the vehicle 600, or installation in the vehicle 600. The hoisting system 400 and the positioning system 300 may lift, lower, or move the lifting armature 102 in response to signals generated by the one or more user control devices 502. Any of the user control devices 502 may detachably connect to one of the control handle assemblies 200.

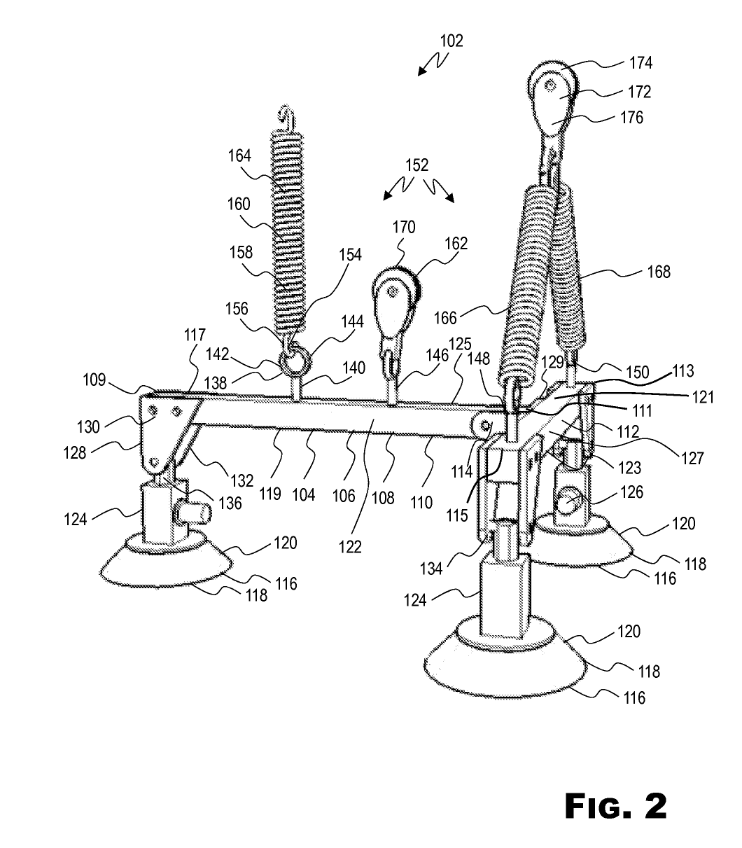

Referring now to FIG. 2, an exemplary embodiment of the lifting armature 102 is illustrated. The lifting armature 102 may include an armature frame 104, multiple lifting devices 116 pivotally connected to the armature frame 104 and configured to detachably connect to the surface of the windshield 602, and at least one hoisting device 152 pivotally connected to the armature frame 104. The armature frame 104 may include multiple elongated members 106, fixedly or pivotally connected to each other. The elongated members 106 may be, at least partially formed of aluminum. In other embodiment the elongated members 106 may be made of another solid substance which would support the lifting of the windshield 602. The illustrated embodiment of the lifting armature 102, differs from the embodiment of the lifting armature 102 illustrated in FIG. 1 in that a second pulley 172 is attached at a different location. Both embodiments are contemplated.

In the illustrated embodiment, the armature frame 104 includes a T-Bar frame 108. In other embodiments, the armature frame 104 may include a triangular shape, a square shape, or other shapes formed by elongated or other members fixedly or pivotally connected. The T-Bar frame may include a longitudinal frame member 110 and a lateral frame member 112. The longitudinal frame member 110 may include a first longitudinal end 109, a second longitudinal end 111, a longitudinal top side 117, a longitudinal bottom side 119, a longitudinal first side 122, and a longitudinal second side 125. The lateral frame member 112 may include a first lateral end 113, a second lateral end 115, a lateral top side 121, a lateral bottom side 123, a lateral first side 127, and a lateral second side 129. The longitudinal frame member 110 may be fixedly connected to the lateral frame member 112 with a bracket 114. The bracket 114 may connect the second longitudinal end 111 to the lateral second side 129 at a position half-way between the first lateral end 113 and the second lateral end 115.

The lifting device 116 may include a vacuum lifter 118. In alternative embodiments the lifting device may include any device which may be detachably connected to the windshield 602, and may maintain the connection when the windshield 602 is lifted or lowered with the hoisting system 400, or moved with the positioning system 300. The vacuum lifter 118 may include a vacuum lifer cup 120 fixedly connected to a mount 124, and an attachment actuator 126. The attachment actuator 126 may be configured to connect the vacuum lifter 118 to the windshield 602, and detach the vacuum lifter 118 from the windshield 602. The vacuum lifter 118 may, in a non-limiting example, include a six (6) inch vacuum cup 120 and mount 124 manufactured by Woods Powr-Grip O.

Pivot mount assemblies 128 may pivotally connect the multiple lifting devices 116 to the armature frame 104. In the embodiment illustrated the multiple lifting devices include three lifting devices 116, one lifting device 116 pivotally mounted on the first longitudinal end 109, one lifting device 116 pivotally mounted on the first lateral end 113, and one lifting device 116 pivotally mounted on the second lateral end 115. Each pivot mount assembly 128 may include a first pivot mounting plate 130, a second pivot mounting plate 132, a pivot bar 134, and a fastener 136. The first pivot mounting plate 130 and the second pivot mounting plate 132 may include a generally triangular and flat metallic plate. One of the first pivot mounting plates 130 may be fixedly connected to the longitudinal first side 122 at the first longitudinal end 109, and one of the second pivot mounting plates 132 may be fixedly connected to the longitudinal second side 125 at the first longitudinal end 109, with for example bolts or rivets. Another of the first pivot mounting plates 130 may be fixedly connected to the lateral first side 127 at the first lateral end 113, and one of the second pivot mounting plates 132 may be fixedly connected to the lateral second side 129 at the first lateral end 113, with for example bolts or rivets. Still another of the first pivot mounting plates 130 may be fixedly connected to the lateral first side 127 at the second lateral end 115, and one of the second pivot mounting plates 132 may be fixedly connected to the lateral second side 129 at the second lateral end 115, with for example bolts or rivets.

The first pivot mounting plates 130 and the second pivot mounting plates may be fixedly connected to the armature frame 104 such that each first pivot mounting plate 130 aligns with a second pivot mounting plate 132 such that a pivot bar 134 may be connected between the two aligned pivot mounting plates 130, 132. The pivot bar 134 may be a metallic generally cylindrical elongated member. A fastener 136 may pivotally connect the mount 124 to the pivot bar 134.

One or more hoisting devices 152 may be pivotally connected to the armature frame 104 with anchor tabs 138. The anchor tabs 138 may include a first anchor tab 144 fixedly connected to the longitudinal top side 117, a second anchor tab 146 fixedly connected to the longitudinal top side 117, a third anchor tab 148 fixedly connected to the lateral top side 121 at the second lateral end 115, and a fourth anchor tab 150 fixedly connected to the lateral top side 121 at the first lateral end 113. Each anchor tab 138 may include a base 140 and an anchor 142. The base 140 may fixedly connect the anchor 142 to the armature frame 104. The base 140 may be a metallic cylindrical member, and one end may be threaded to screw the base 140 into the armature frame 104. In other embodiments the base 140 may not be threaded and may be welded, onto the armature frame 104 or connected by other means known in the art. The anchor 142 may include a metallic cylindrical member formed in a circle. The hoisting devices 152 may be pivotally connected to the anchor 142 with an anchor member 154, which may include a clasp 156 or other mechanical fastener as known in the art. Other connectors known in the art may be used in place of the anchor tabs 138 to pivotally connect the hoisting devices 152 to the armature frame 104.

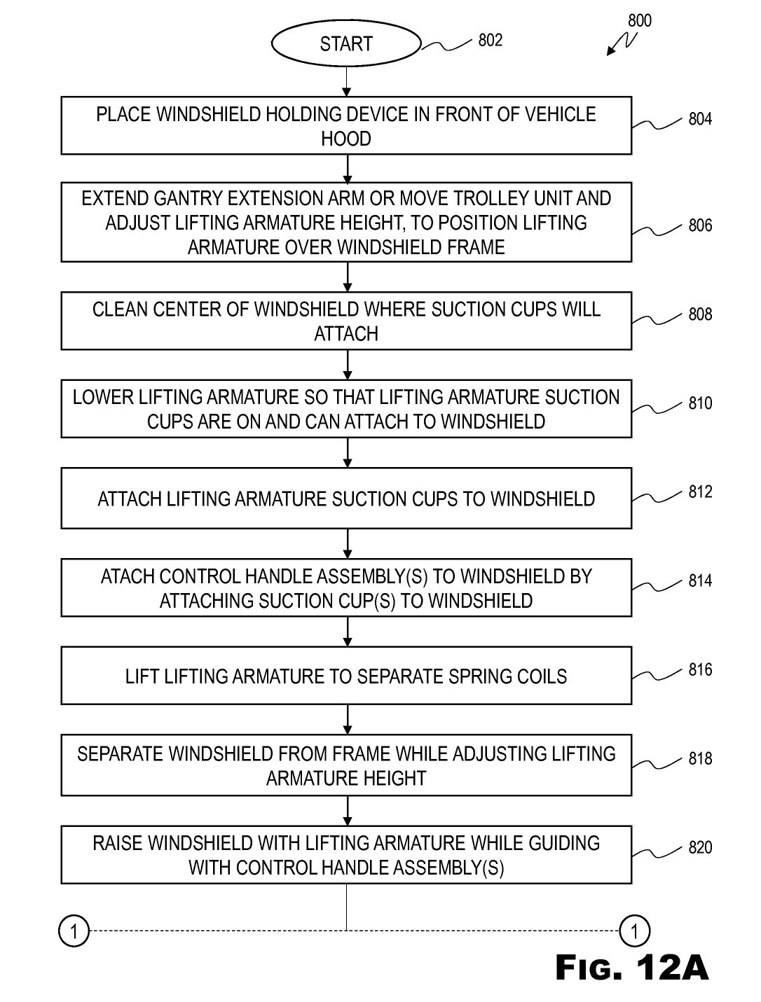

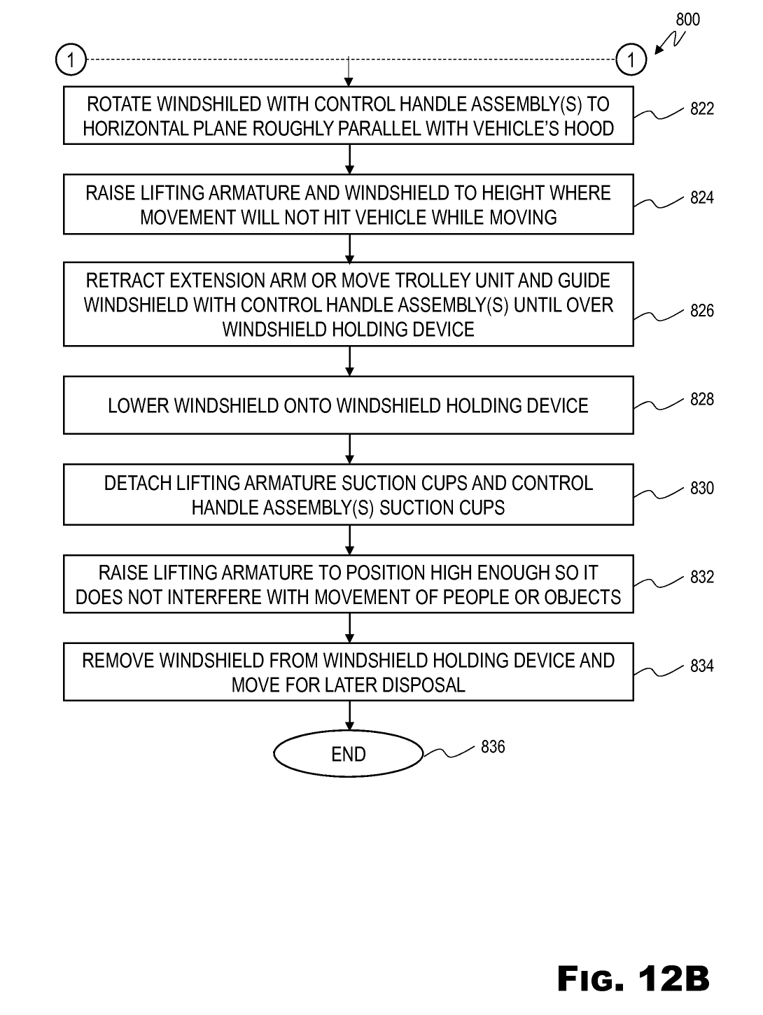

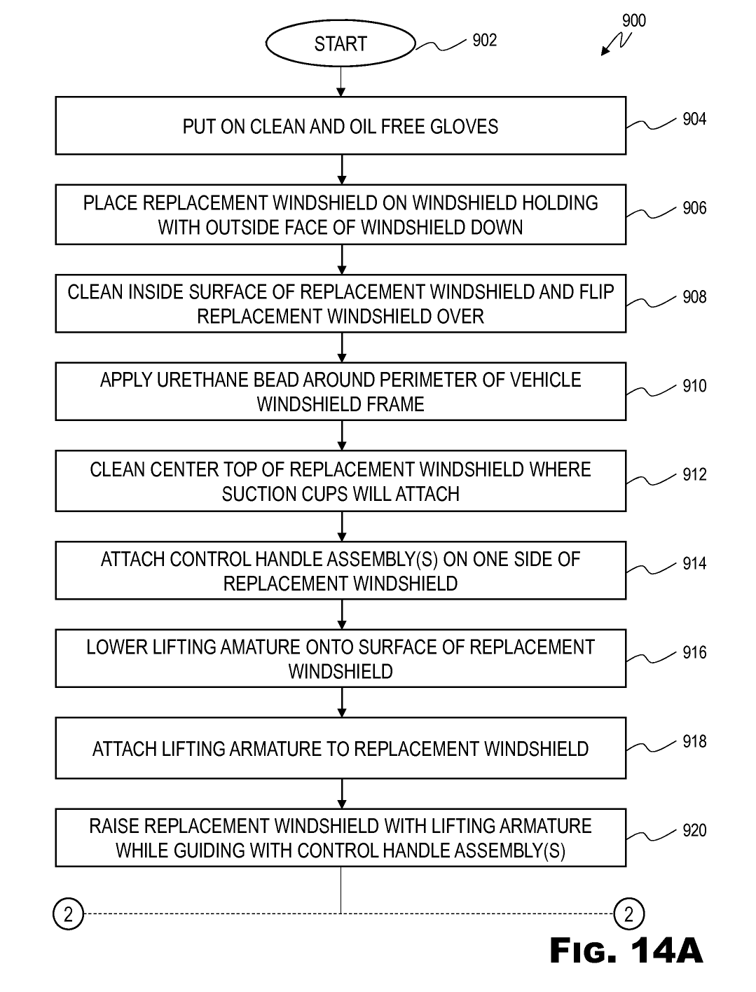

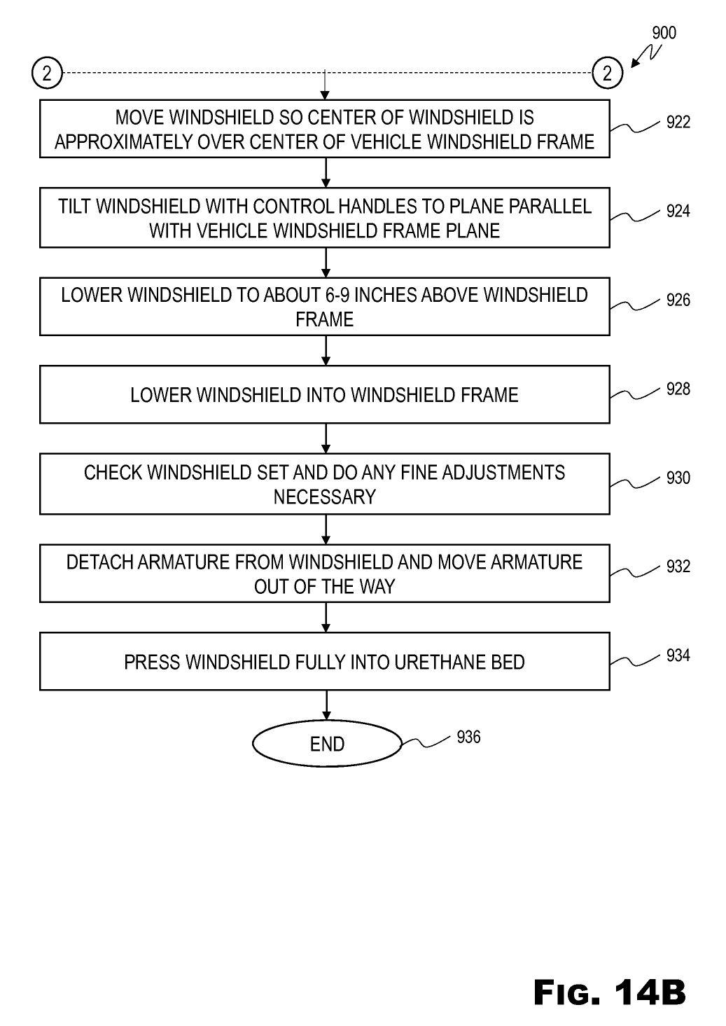

The hoisting devices 152 may be devices which are operable to connect the armature frame 104 to the hoisting system 400. The hoisting devices 152 may include one or more flexible members 158 and one or more armature pulleys 162. Each of the flexible members 158 may include an elongated resilient member which may be pressed or pulled but returns to its former shape when released. The flexible member 158 may include a spring 160. Springs 160 may assist in removal of the windshield 602 from the vehicle 600 by allowing a technician, or other person removing the windshield 602, to observe the tension from the windshield 602 on the armature frame 104, by observing when coils of any of the springs 160 begin to separate. Springs 160 may also allow for some adjustment to the placement of the windshield 602, when installing the windshield 602 in the vehicle 600, while the lifting armature 102 holds the windshield 602 in place. These advantages will be further explained in relation to methods 800, 900 illustrated and described in FIGS. 12A, 12B, 14A, and 14B. Any of the springs 160 may include a helical metallic coil, which may exert constant tension or absorb movement.

Springs 160 may include a first spring 164, a second spring 166, and a third spring 168. The first spring 164 may be pivotally connected to the first anchor tab 144. The second spring 166 may be pivotally connected to the third anchor tab 148. The third spring 168 may be pivotally connected to the fourth anchor tab 150. The first spring 164 may, in a non-limiting example, include a three quarters (¾) inch by seven and nine sixteenths (7 9/16) inch, with one thousand and fifty-five ten thousandths (0.1055) wire extension spring. The second spring 166 and/or the third spring 168 may, in a non-limiting example, include a three quarters (¾) inch by seven and three eighths (7⅜) inch, with eighty-one thousandths (0.081) wire extension spring.

The armature pulleys 162 may include a pulley wheel 174 with a grooved rim around which one of the cables 418 may pass. The pulley wheel 174 may turn, at least partially within, and be rotatably connected to a pulley frame 176. The pulley frame 176 may include a clasp 156, or other fastener known in the art, for operably connecting the armature pulley 162 to one of the anchor tabs 138 or one of the flexible members 158. The armature pulleys 162 may include a first armature pulley 170 and a second armature pulley 172. The first armature pulley 170 may be pivotally connected to the second anchor tab 146. The second armature pulley 172 may be pivotally connected to the second spring 166 and the third spring 168.

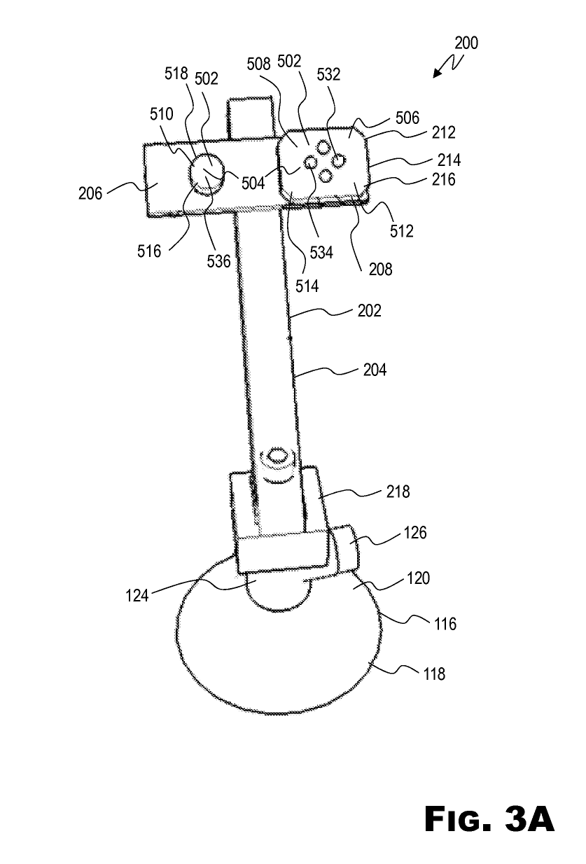

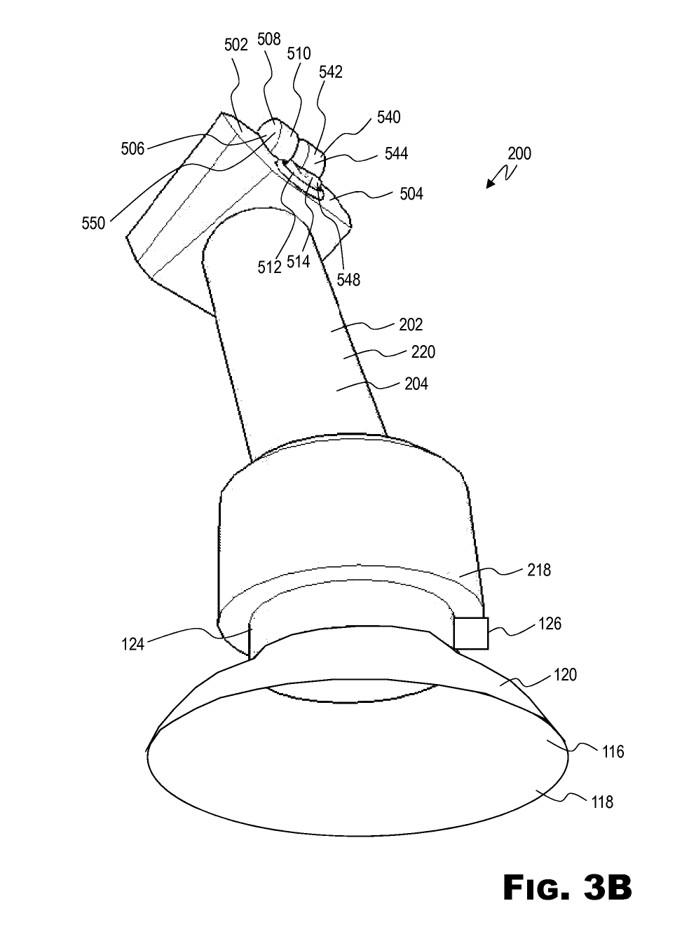

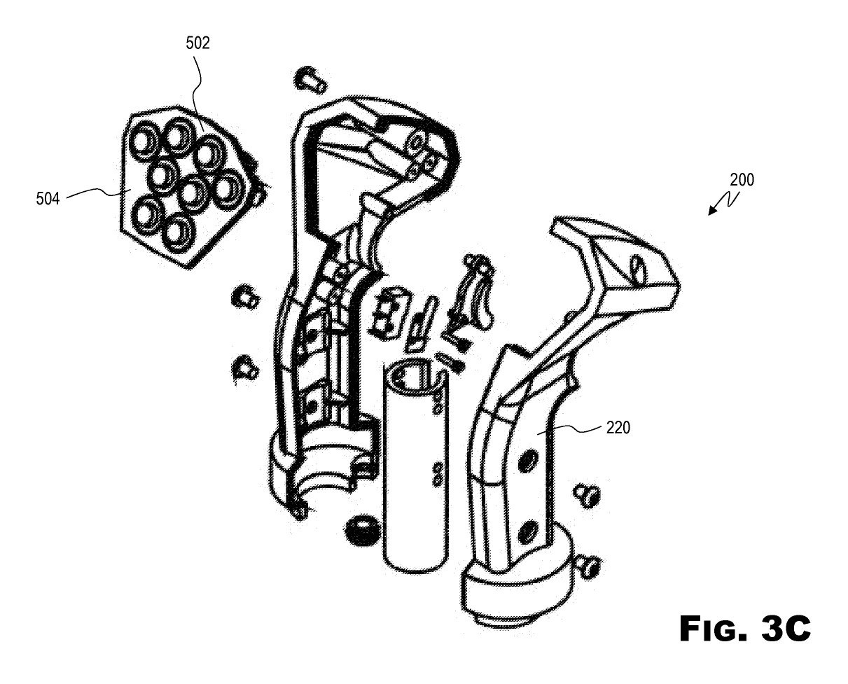

Referring now to FIG. 3A an exemplary first embodiment of a control handle assembly 200 and an exemplary embodiment of a user control device 502 are illustrated in a perspective view. The control handle assembly 200 may include a handle 202, a user control device mount 206, and the lifting device 116. The lifting device 116 may be similar to the lifting devices 116 of the lifting armature 102, but may, in one embodiment include a smaller vacuum lifter 118. For example, the vacuum lifter 118 may include a four (4) inch vacuum cup 120 and mount 124 manufactured by Woods Powr-Grip®. A lifter attachment assembly 218 may operably connect the lifting device 116 to the handle 202. For example, the lifter attachment assembly 218 may be fixedly attached to the lifting device 116. The control handle assembly 200 may include an attachment actuator 126 which may connect and detach the lifting device 116 from the windshield 602.

The handle 202 may include a metallic elongated member 204. The user control device mount 206 may be fixedly connected to the handle 202 such that a human can grasp the handle 202 with a hand, and use the thumb of that hand to interact with a user interface 504 of the user control device 502. The user control device mount 206 may be any type mount to which a user control device 502 may be connected. In one embodiment the user control device mount 206 may be a rectangular, generally flat metallic member fixedly connected to the handle 202 in a generally perpendicular orientation.

The user interface 504 may include any user input device 532 or group of user input devices 532 with which a person may interact to control the hoisting system 400 to lift and/or lower the lifting armature 102, and/or to control the positioning system 300 to move the lifting armature 102 in a first direction and/or a second direction. In one embodiment, the user input devices 532 may include buttons 534 and dials 536. In other embodiments, the user input devices may include switches, keyboards, interactive displays, levers, voice activated controls, and/or any other operator input devices 532 that a person skilled in the art would understand would be functional in the disclosed embodiments.

The user interface 504 may include a hoisting user interface 506 and/or a positioning user interface 512. The hoisting user interface 506 may include any user input device 532 or group of user input devices 532 with which a person may interact to control the hoisting system 400 to lift and/or lower the lifting armature 102. The positioning user interface 512 may include any user input device 532 or group of user input devices 532 with which a person may interact to control the positioning system 300 to move the lifting armature 102 in a first direction and/or a second direction. In some embodiments, the user interface 504 may include a speed interface 518, which may include any user input device 532 or group of user input devices 532 with which a person may interact to control the speed at which the lifting armature 102 moved. The speed interface 518 may include a hoisting speed interface 510 and a positioning speed interface 516. A person may interface with the hoisting speed interface 510 to control the speed at which the hoisting system 400 lifts and/or lowers the lifting armature 102. A person may interface with the positioning speed interface 516 to control the speed at which the positioning system 300 moves the lifting armature 102 in a first direction and/or a second direction. In other embodiments, the speed interface 518 may be an integral component of the hoisting user interface 506 and/or the positioning user interface 512.

In one embodiment the user interface 504 includes a dial 536 for adjusting the speed at which the lifting armature 102 may be moved, and buttons 534 for moving the lifting armature 102. Depressing first one of the buttons 534 may lift the lifting armature 102; depressing a second one of the buttons 534 may lower the lifting armature 102; depressing a third one of the buttons 534 may move the lifting armature 102 in a first direction; and depressing a fourth one of the buttons 534 may move the lifting armature 102 in a second direction.

The control handle assembly 200 may include a user control attachment device 208 which may detachably connect the user control device 502, or one or more components of the user control device 502 to the user control device mount 206. In one embodiment, the user control attachment device 208 may include a hook and eye device 212, such as for example Velcro®. The hook and eye device 212 may include a hook portion 214 and an eye portion 216, which connect to each other when pushed together. One of the hook portion 214 and the eye portion 216 may be connected to the user control device mount 206, and the other may be connected to the user control device 502. In other embodiments, the user control attachment device 208 may include hooks, snaps, straps, and other devices which may detachably connect one portion to another as would be known in the art.

Referring now to FIG. 3B, an exemplary second embodiment of the control handle assembly 200 and the user control device 502 are illustrated in a perspective view. In the second embodiment, a housing 220 forms the elongated handle 202, and elongated member 204. The user control device 502 may be an integral part of control handle assembly 200, at least partly enclosed by the housing 220. The user interface 504 may include infinite position switches 550 and a three position switch 548. The hoisting directional interface 508 and the hoisting speed interface 510 may be incorporated into one user input device 532, for example one of the infinite position switches 550. As the infinite position switch 550 is moved in a first direction, the user control device 502 may generate a lift signal. As the infinite position switch 550 is moved in a second opposite direction, the user control device 502 may generate a lower signal. The speed at which the hoisting system 400 lifts or lowers the lifting armature 102 may be in response to a hoisting speed signal. The hoisting speed signal may be generated at least in partially in response to how far in the first direction or the second direction the infinite position switch 550 is moved.

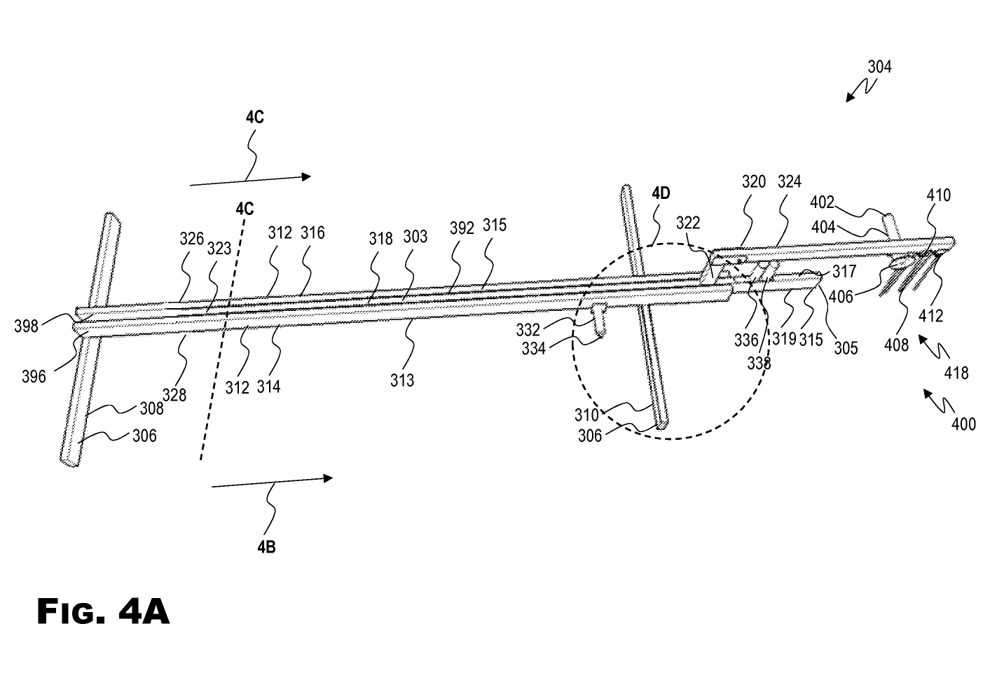

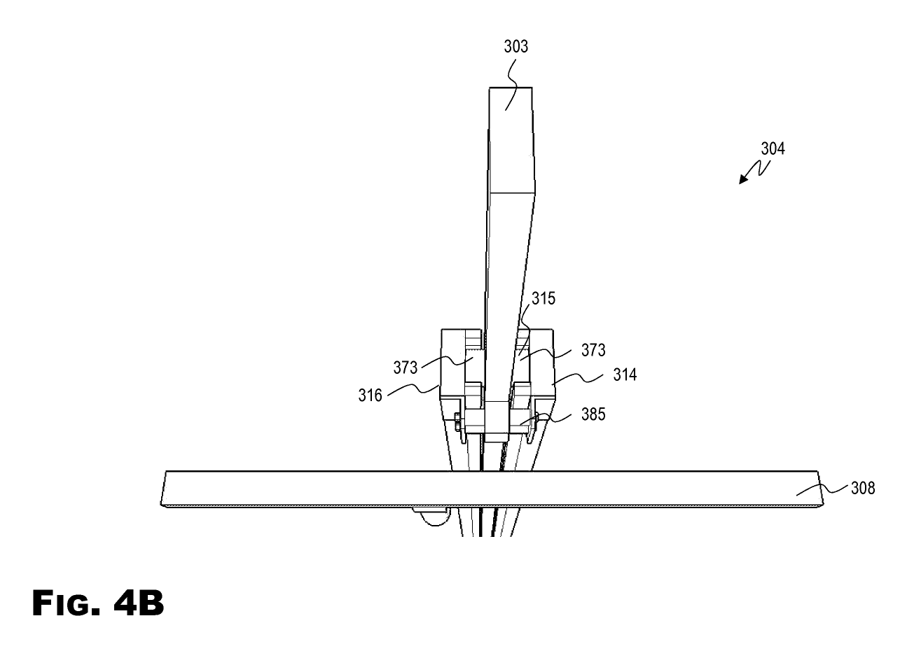

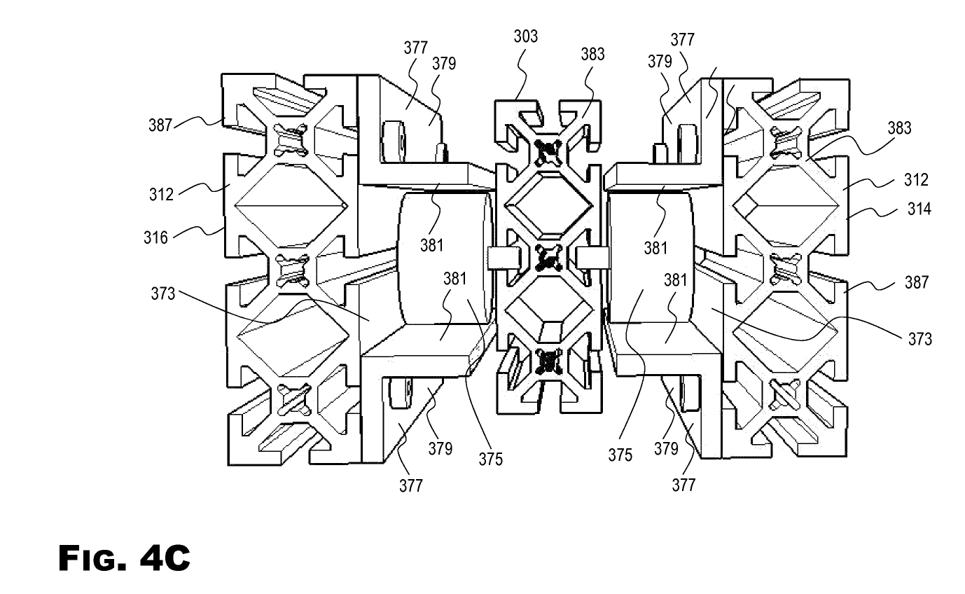

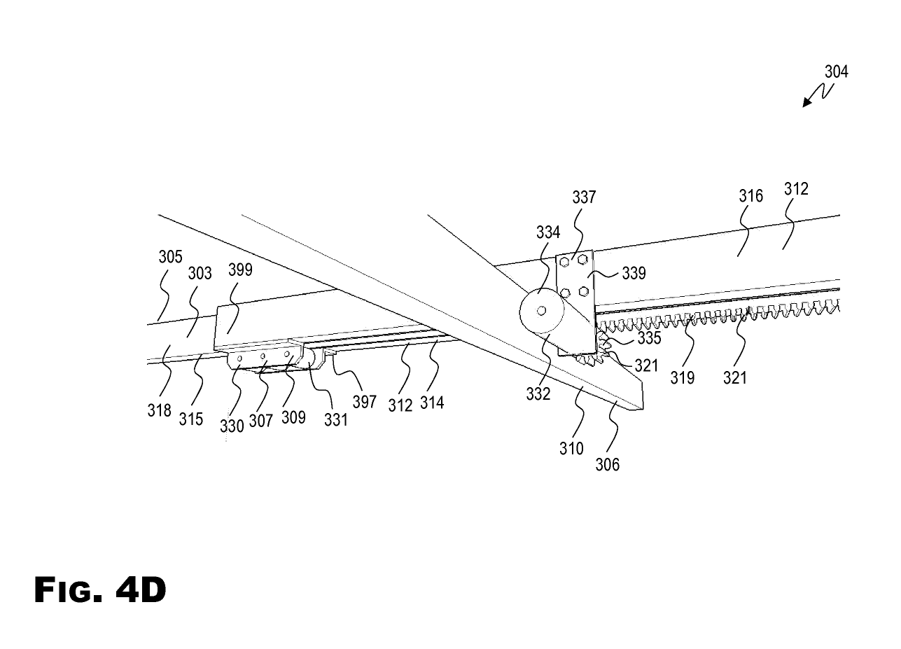

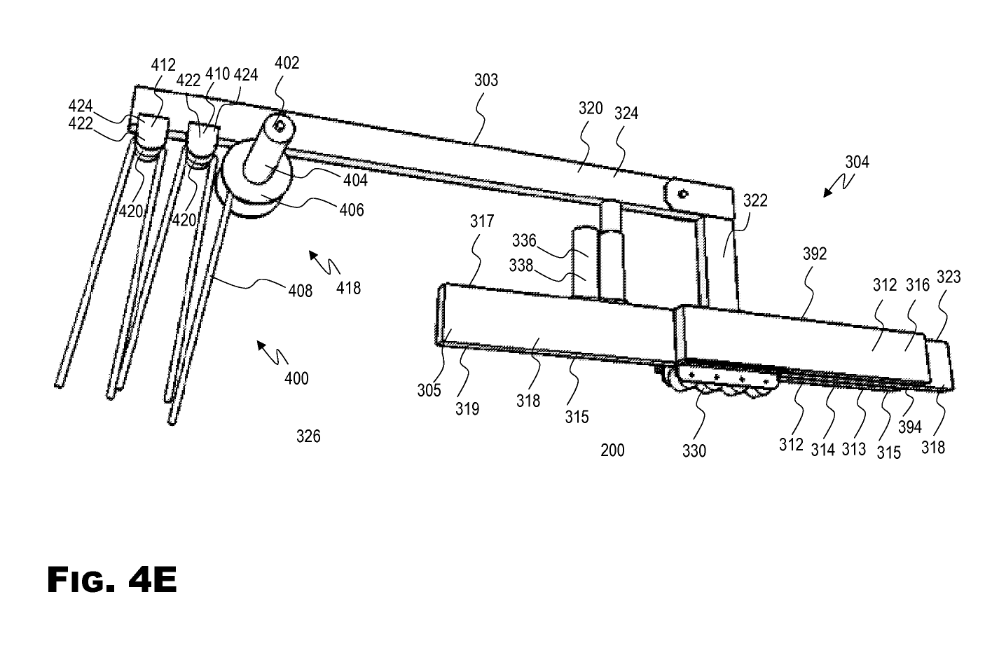

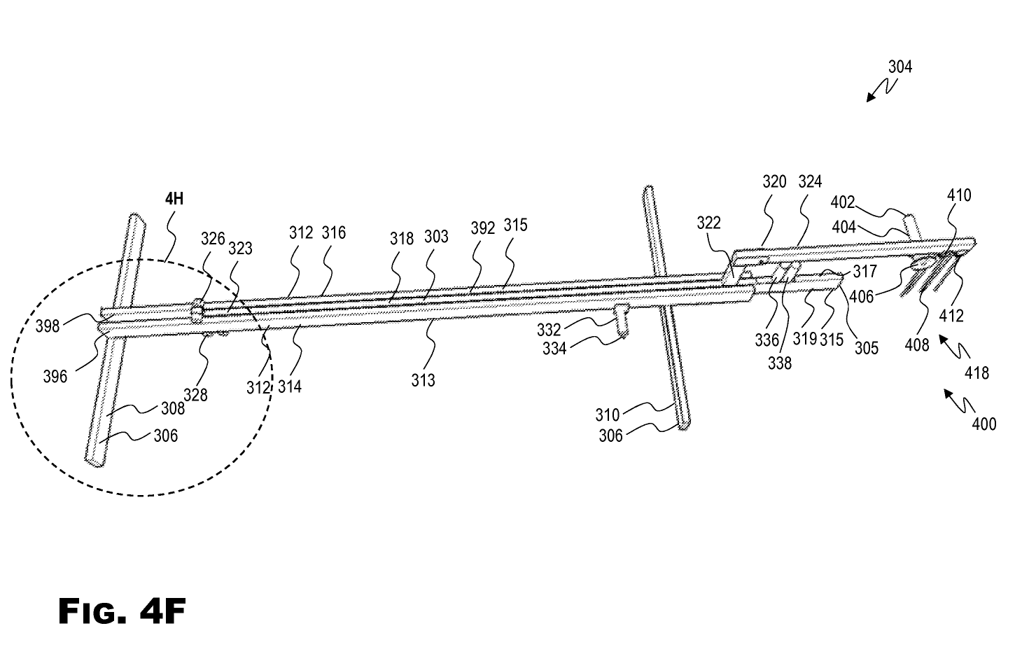

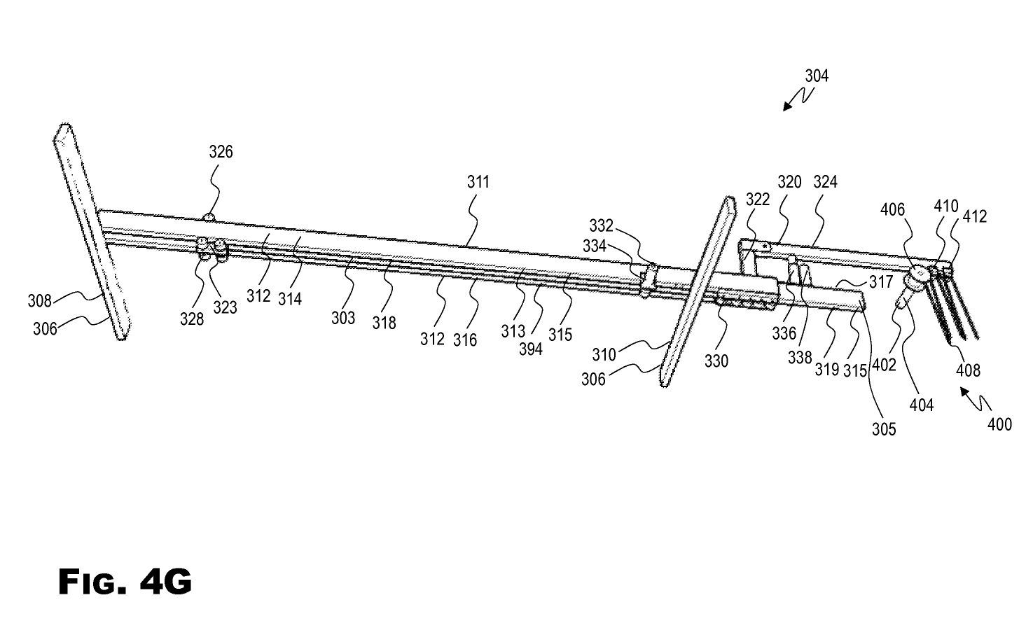

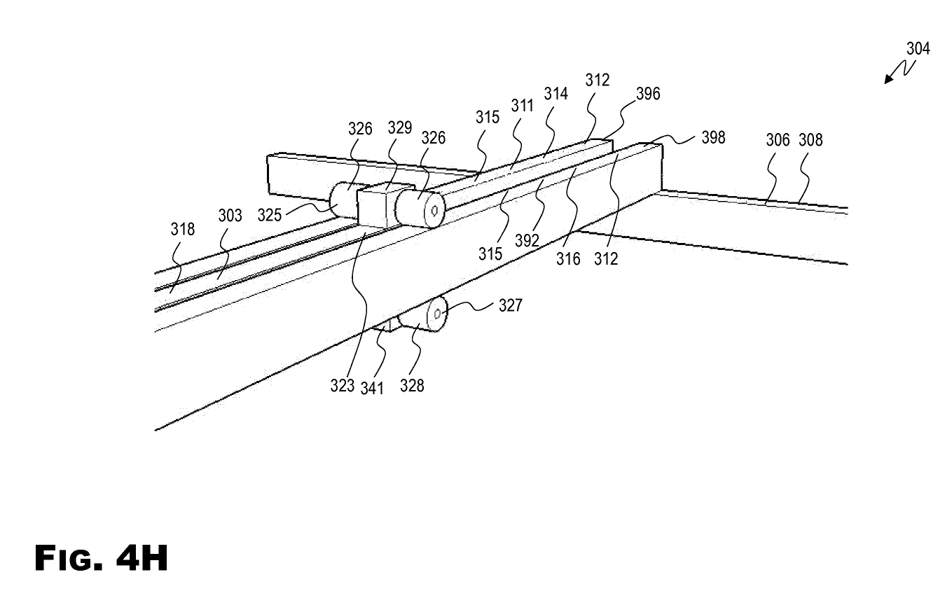

The user interface 504 may include a crane arm interface 540 for controlling a crane 336 actuator (shown in relation to FIGS. 4A-4H). The crane actuator 336 moves a first crane member 322 in relation to a second crane member 324 as shown and explained in more detail in relation to FIGS. 4A-4H. The crane arm interface 540 may include a crane directional interface 544 and a crane arm speed interface 544 which may be incorporated into one user input device 532, for example one of the infinite position switches 550. In other embodiments, there may be separate user input devices 532 for the crane directional interface 544 and the crane arm speed interface 544. As the infinite position switch 550 is moved in a first direction, the user control device 502 may generate a crane lift signal. As the infinite position switch 550 is moved in a second opposite direction, the user control device 502 may generate a crane lower signal. The speed at which the first crane member 322 is moved in relation to the second crane member 324 to lift or lower the lifting armature 102 may be in response to a crane speed signal. The crane speed signal may be generated at least partially in response to how far in the first direction or the second direction the infinite position switch 550 is moved.

The user interface 504 may include the positioning user interface 512. The positioning interface may include any user input device 532 or group of user input devices 532 with which a person may interact to control the positioning system 300 to move the lifting armature 102 in a first direction and/or a second direction. The input device 532 may for example include the three position switch 548. When the three position switch 548 is in a first position the lifter armature 102 may move in the first direction. When the three position switch 548 is in a second position the lifter armature 102 may move in the second direction. When the three position switch 548 is in a third position the lifter armature 102 may not move in the first direction or the second direction. In some embodiments the positioning user interface 512 may be connected to a positioning speed interface 516 which may be located remotely from the control arm assembly 200, for example in the service vehicle 606. The positioning speed interface 516 may be used by a user to adjust the speed the lifting armature 102 is moved in the first direction or the second direction.

Referring now to FIG. 3C, an exemplary third embodiment of the control handle assembly 200 is illustrated in an expanded view. The control handle assembly 200 includes a housing 220 and integrated user control device 502 with the user interface 504. The housing 220 may be configured to enclose wiring (not shown) which connects the user interface 504 with controls in the service vehicle 606 (not shown) and/or the gantry 302.

Referring now to FIG. 4A, an exemplary embodiment of the mobile gantry 302 is shown. The mobile gantry 304 may include guide bars 312, an extension arm assembly 303, and a positioning actuator 332. The guide bars 312 may include a first guide bar 314 and a second guide bar 316. The extension arm assembly 303 may be slidingly connected between the first guide bar 314 and the second guide bar 316, and may include an extension arm 318. The extension arm 318 may include an extension arm first end 305, an extension arm second end 323, an extension arm top 317, and an extension arm bottom 319. The positioning actuator 332 may be connected to the extension arm 318 to extend and retract the extension arm first end 305 from between the first guide bar 314 and the second guide bar 316. A hoisting mechanism 418 may be fixedly mounted on the extension bar assembly 303. The lift armature 102 may be moved in a first direction when the extension arm 318 is extended and in a second direction when the extension arm 318 is retracted. The guide bars 312 and extension arm 318 may be solid elongated members. In some embodiments the guide bars 312 and extension arm 318 may be metallic and may be made from aluminum or an aluminum alloy. For example, the guide bars 312 and/or the extension arm 318 may be manufactured by the 80/20® company through aluminum extrusion.

The guide bars 312 may be supported by cross bar supports 306. For example the cross bar supports 306 may be fixedly connected to the guide bars 312 on the first guide bar bottom 313 and the second guide bar bottom 394, and be generally perpendicular to the guide bars 312. The cross bar supports 306 may be solid elongated members. In some embodiments the cross bar supports 306 may be metallic and may be made from aluminum or an aluminum alloy. For example, the cross bar supports 306 may be manufactured by the 80/20® company through aluminum extrusion. The cross bar supports 306 may be fixedly connected to the service vehicle 606 (not shown) which may be a van, so that the system 100 may be mobile. The cross bar supports 306 may include a first cross bar support 308 which may be fixedly connected to the first guide bar 314 at a first guide bar back end 396 and/or the second guide bar 316 at a second guide bar back end 398. The cross bar supports 306 may also include a second cross bar support 310 which may be fixedly connected to the first guide bar 314 at and/or the second guide bar 316 at a location different from where the first cross bar support 308 is connected.

The extension arm assembly 303 may include a crane arm 320 and a crane actuator 336. The crane arm 320 may include a first crane member 322 and a second crane member 324. The first crane member 322 may be fixedly connected to and generally perpendicular to the extension arm 318. The second crane member 324 may be pivotally connected to the first crane member 322. The crane actuator 336 may be connected to the second crane member 324 and the extension arm 318, and may be operable to move the second crane member 324 between a first position and a second position. The hoisting mechanism 418 may be fixedly mounted on the second crane member 324. The first crane member 322 and the second crane member 324 may be solid elongated members. In some embodiments the first crane member 322 and/or the second crane member 324 may be metallic and may be made from aluminum or an aluminum alloy. For example, the first crane member 322 and/or the second crane member 324 may be manufactured by the 80/20® company through aluminum extrusion. The crane actuator 336 may be a motorized ball and screw unit which pivots the second crane member 324 in relation to the first crane member 322. As the extension arm 318 is extended and retracted from between the guide bars 312, the crane arm 320 may also be extended and retracted, as may the hoisting mechanism 418 when it is fixedly mounted on the second crane member 324. When the hoisting mechanism 418 is connected to the lifting armature 102, the lifting armature 102 may be moved in a first direction when the extension arm 318 is retracted, and in a second direction when the extension arm 318 is extended.

The hoisting system 400 may include a hoisting power source 402. The hoisting power source 402 may be any power source which drives the hoisting system 400 to lift and/or lower the lifting armature 102. The hoisting power source 402 may include a hoisting motor 404 fixedly mounted on the extension arm assembly 303. The hoisting motor 404 may be an electric motor configured to convert AC or DC electrical power into mechanical power including rotational torque and speed. The hoisting mechanism may include a cable spool 406, a first hoisting pulley 410, and a second hoisting pulley 412. The cable spool 406 may include a generally cylindrical device with two ends, and a spool axis between the two ends, each end having a rim or ridge. The hoisting motor 402 may be drivingly connected to the cable spool 406 to rotate the cable spool 406 around the spool axis in a first rotational direction and a second rotational direction. The cable spool 406 may be configured to have the cable 418 wound around it, such that when the cable spool 406 rotates in the first rotational direction the cable 418 unwinds from the cable spool 406, and when the cable spool 406 rotates in the second rotation directions the cable 418 winds onto the cable spool 406.

The first and/or second hoisting pulley 410, 412 may include a pulley wheel 420 with a grooved rim around which one of the cables 418 may pass. The pulley wheel 420 may turn, at least partially within, and be rotatably connected to a pulley frame 422 (shown in relation to FIG. 4E). The pulley frame 422 may include a mounting assembly 424 (shown in relation to FIG. 4E), configured to fixedly connect the first and/or second hoisting pulley 410, 412 to the extension arm assembly 303.

Referring now to FIG. 4B, portion of the mobile gantry 304 of FIG. 4A in a perspective view looking in the direction of the arrow in FIG. 4A marked 4B is illustrated. The mobile gantry 304 may include one or more roller tracks 315. The roller tracks 315 may include one or more interior roller tracks 373. The interior roller tracks 373 may be formed by the guide bars 312 and the extension arm 303. The guide bars may be fixedly attached to each other by a bracket 385.

Referring now to FIG. 4C, a cross section of the mobile gantry of FIG. 4A along the dashed line 4C in the direction of the arrow marked 4C in Fig. A is illustrated. The guide bars 312 may include a main member 387 with a web profile 383, and one or more elongated brackets 377. The elongated brackets 377 may include an attachment surface 379 and a roller surface 381. The roller surfaces 381 may form one or more interior roller tracks 373.

The extension arm 303 may also include a web profile 383. One or more interior guide rollers 375 may be rotatably coupled to the extension arm 303. The interior guide rollers 375 may roll in the interior roller tracks 373 as the extension arm 303 is extended and retracted from between the guide bars 312.

Referring now to FIG. 4D a portion of the mobile gantry 304 of FIG. 4A in circle 4D is illustrated in a perspective view. The first guide bar 314 may include a first guide bar front end 397, and the second guide bar 316 may include a second guide bar front end 399. The mobile gantry 304 may include an extension roller assembly 330 to support the extension arm assembly 303 as the extension arm 318 is extended and retracted from between the guide bars 312. The extension roller assembly 307 may include extension rollers 331 rotatably connected to an extension roller connection assembly 307. The extension roller connection assembly 307 may be fixedly connected to the guide bars 312 at the first guide bar front end 397 and the second guide bar front end 399. For example, the extension roller connection assembly 307 may include two brackets 309, one of which is fixedly connected to the first guide bar 314, and the other which is fixedly connected to the second guide bar 316. The extension rollers 331 may be rotatably connected between the brackets 307. Part of the extension arm bottom 319 may include a roller track 315. When the extension arm 318 extends and retracts from between the guide bars 312, the extension rollers 331 may roll in the roller track 315 and support the extension arm assembly 303.

A portion of the extension arm bottom 319 may include teeth 321. The positioning actuator 332 may include a positioning motor 334 and a positioning gear 335. The positioning motor 334 may be an electric motor which is connected to the positioning gear 335 to rotate the positioning gear 335. The positioning motor may be fixedly connected to one of the guide bars 312 with a positioning motor attachment assembly 337. The positioning motor attachment assembly 337 may include a bracket 339 fixedly connected to the housing of the positioning motor 334. The positioning gear 335 may include teeth 321 which may mesh with the teeth 321 on the extension arm bottom 319. The positioning motor 334 may rotate the positioning gear 335 in response to signals from the user control device 502. When the positioning gear 335 rotates, the teeth 321 on the positioning gear 335 may engage the teeth 321 on the extension arm bottom 319 extending or retracting the extension arm 318 from between the guide bars 312. In other embodiments, the positioning gear 335 may engage a chain (not shown) which may be connected to the extension arm 318 in such a manner as to extend and retract the extension arm 318 from between the guide bars 312 when the positioning gear rotates. Other positioning actuators 332 may be alternatively used to extend and retract the extension arm 318 from between the guide bars 312 as would be known by ordinary persons skilled in the art.

Referring now to FIG. 4F-4H second exemplary embodiment of the mobile gantry 304 is illustrated. FIG. 4F and FIG. 4G are perspective views of the mobile gantry 304, and FIG. 4H is a perspective view of a portion of the mobile gantry 304 in the circle marked 4H in FIG. 4F. The second embodiment of the mobile gantry 304 is similar to the first embodiment, but instead of interior roller tracks 373 and interior guide rollers 375, the second embodiment of the mobile gantry may include roller guides 315 on the a first guide bar top 311, a first guide bar bottom 313, a second guide bar top 392, and a second guide bar bottom 394, a top roller assembly 325, and a bottom roller assembly 327.

The first guide bar 314 may include the first guide bar top 311 with a roller track 315, and the first guide bar bottom 313 with a roller track 315. The second guide bar 316 may include the second guide bar top 392 with a roller track 315, and the second guide bar bottom 394 with a roller track 315. A top roller assembly 325 may include top guide rollers 326 rotatably connected to a top roller connector assembly 329. The top roller connector assembly 329 may be fixedly connected to the extension arm top 317 on the extension arm second end 323.

A bottom roller assembly 327 may include bottom guide rollers 328 rotatably connected to a bottom roller connector assembly 341. The bottom roller connector assembly 341 may be fixedly connected to the extension arm bottom 319 on the extension arm second end 323. The top guide rollers 326 may be disposed to roll in the roller tracks 315 on the first guide bar top 311, and the second guide bar top 392 when the extension arm 318 is extended and retracted. The bottom guide rollers 328 may be disposed to roll in the roller tracks 315 on the first guide bar bottom 313, and the second guide bar bottom 394 when the extension arm 318 is extended and retracted.

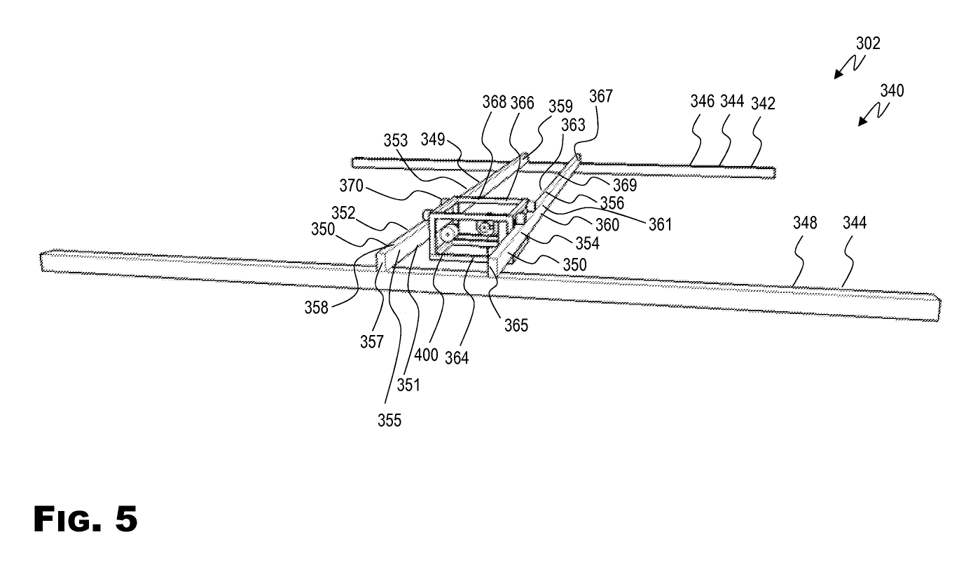

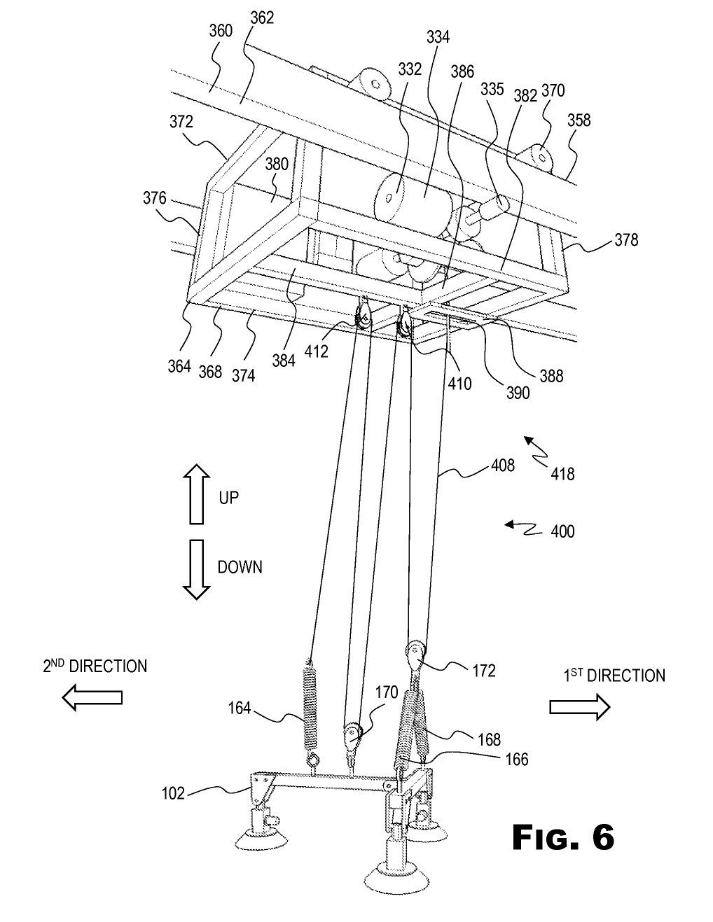

Referring now to FIG. 5, an exemplary stationary gantry 302 and trolley unit 364 are shown in a perspective view. The positioning system 300 may include a stationary gantry 340 and a trolley unit 364, in place of the mobile gantry 304, in an alternative embodiment. The stationary gantry 302 may include rails 350. The rails 350 may include a first rail 352; and a second rail 354. The trolley unit 364 may be positioned between, supported by, and configured to move between the first rail 352, and the second rail 354. The positioning actuator 332 (shown and described in relation to FIGS. 6-8) may be drivingly connected to the trolley unit 364, and configured to drive the trolley unit 364 in a first direction and a second direction, between the first rail 352 and the second rail 354. The hoisting mechanism 418 may be fixedly mounted on the trolley unit 364. The lift armature 102 may be moved in the first direction when the trolley unit 364 moves in the first direction, and in the second direction when the trolley unit 364 moves in the second direction.

The first rail 352 may be a generally elongated member. The first rail 352 may include a first rail top 349, a first rail bottom 351, a first rail outer side 353, a first rail inner side 355, a first rail front end 357, and a first rail rear end 359. The second rail 354 may be a generally elongated member with a cross section --. The second rail 354 may include a second rail top 356, a second rail bottom 360, a second rail outer side 361, a second rail inner side 363, a second rail front end 365, and a second rail rear end 367.

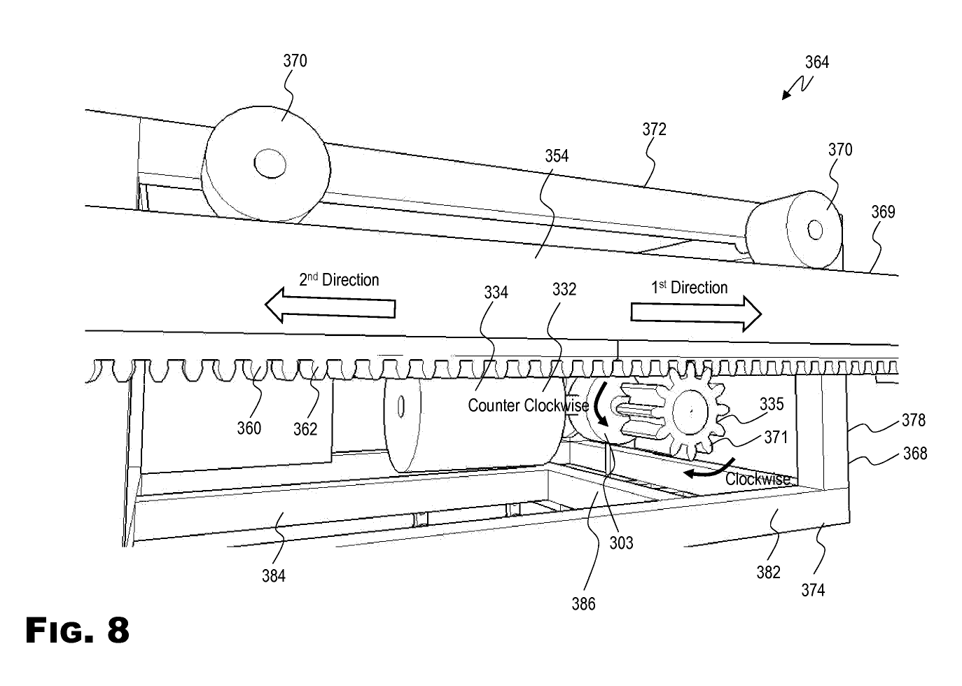

The first rail top 349 may include a first rail roller track 358. The second rail top 356 may include a second rail roller track 369. The first rail roller track 349 and/or the second rail roller track 369 may be configured such that one or more rollers 370, rotatably connected to the trolley unit 364, may roll along or within the first rail roller track 349 and/or the second rail roller track 369. In one embodiment, the first rail roller track 349 and/or the second rail roller track 369 may include a smooth, hard, and level surface. In another embodiment, first rail roller track 349 and/or the second rail roller track 369 may include a smooth, hard, and level surface with a ridge on either side. Other embodiments of the first rail roller track 349 and/or the second rail roller track 369 may include different cross section shapes which correlate to the shape of the one or more rollers 370 such that the rollers 370 may roll along or within the first rail roller track 349 and/or the second rail roller track 369. The first rail bottom 351 and/or the second rail bottom 360 may include teeth 362 (shown and described in relation to FIG. 8). The entire first rail bottom 351 and/or second rail bottom 360 may include teeth 362 or just a portion of first rail bottom 351 and/or the second rail bottom 360. Both first rail bottom 351 and/or the second rail bottom 360 may include teeth 362, or just one of first rail bottom 351 and/or the second rail bottom 361 may include teeth 362.

The stationary gantry 302 may include a frame 342 which includes the rails 350 and one or more cross bar supports 344. The cross bar supports 344 may be generally elongated members. The cross bar supports 344 may include a first cross bar support 346 and a second cross bar support 348. The first cross bar support 346 may include a first cross bar top 345, and the second cross bar support 348 may include a second cross bar top 347. The cross bar supports 344 may be fixedly connected within a stationary structure, such a service shop or garage. The rails 350 may be fixedly connected to, and supported by, the cross bar supports 344. The first rail bottom 351 may be fixedly connected to the first cross bar top 345 near the first rail rear end 359, and fixedly connected to the second cross bar top 347 near the first rail front end 357. The second rail bottom 360 may be fixedly connected to the first cross bar top 345 near the second rail rear end 367, and fixedly connected to the second cross bar top 347 near the second rail front end 365.

One or more of the rails 350 and cross bar supports 344 may be metallic and may be made from aluminum or an aluminum alloy. For example, one or more of the rails 350 and cross bar supports 344 may be manufactured by the 80/20® company through aluminum extrusion. One or more of the rails 350 and cross bar supports 344 may include a web profile 383 (shown in relation to the mobile gantry 304 in FIG. 3C).

Referring now to FIG. 6 an exemplary embodiment of the trolley unit 364, connected to an exemplary embodiment of the hoisting system 400 and the lifting armature 102 are shown in a perspective view.

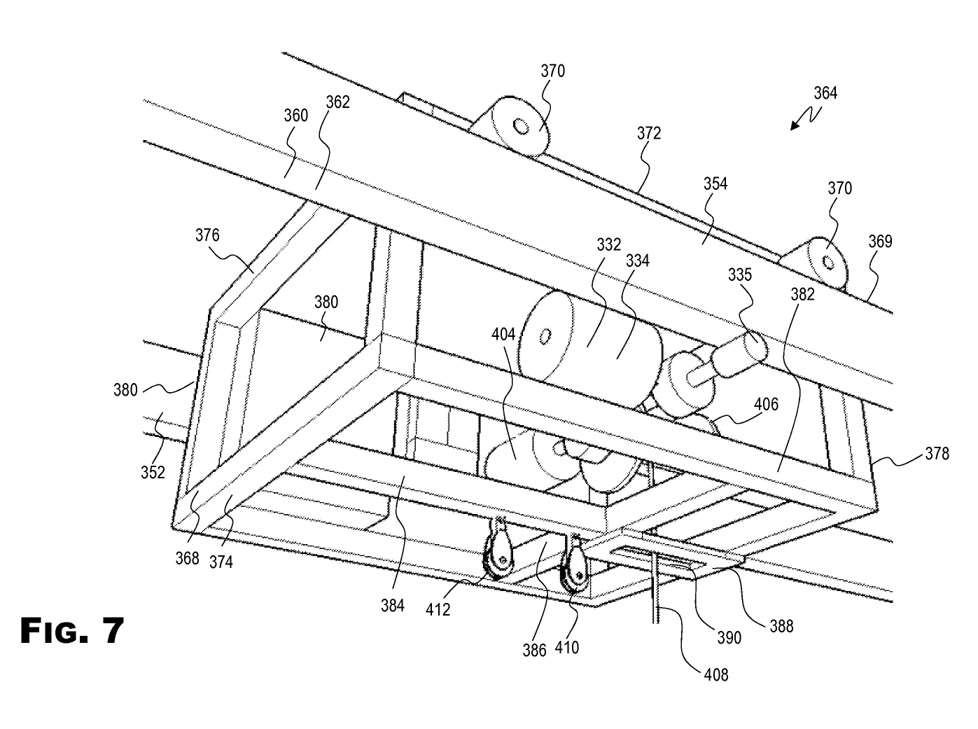

Referring now to FIG. 7, the trolley unit 364 of FIG. 6 with a portion of the first rail 352 and the second rail 354 is shown in a perspective view. The trolley unit 364 may include a trolley housing 366. In one embodiment the trolley housing 366 may be a trolley frame 368. The trolley frame 368 may include generally elongated members fixedly connected together. The trolley frame 368 may have a three dimensional rectangular shape. The trolley housing 368 may include a trolley top 372, a trolley bottom 374, a trolley front 376, a trolley rear 378, a trolley first side 380, a trolley second side 382, a bottom front frame member 384, a bottom side to side frame member 386, and a spool slot frame member 388 with a slot 390. The bottom side to side frame member 386 may be a generally elongated member spanning across the trolley bottom 374 from the trolley first side 380 to the trolley second side 382. The bottom side to side frame member 386 may be generally perpendicular to the trolley first side 380 and the trolley second side 382. The bottom front frame member 384 may be a generally elongated member on the trolley bottom 374, spanning from the trolley front 376 to the bottom side to side frame member 386. The bottom front frame member 384 may be generally perpendicular to the trolley front and the bottom side to side frame member 386. The spool slot frame member 388 may be a generally flat rectangular metallic member, spanning from the trolley rear 378 to the bottom side to side frame member 386. The slot 390 may be a rectangular shaped aperture.

Two or more rollers 370 may be rotatably connected to the trolley first side 380 (shown in relation to FIG. 9) near the trolley top 372. Two or more rollers 370 may be rotatably connected to the trolley second side 382 near the trolley top 372. The rollers 370 may roll along the first rail roller track 358 and the second rail roller track 369 when the trolley unit 364 moves between the first rail 352 and the second rail 354. The first hoisting pulley 410 and the second hoisting pulley 412 may be fixedly connected to the trolley frame 368. In the illustrated embodiment, the first hoisting pulley 410 and the second hoisting pulley 412 are fixedly connected bottom front frame member 384. The cable spool 406 may be at least partially enclosed by the trolley frame 368. The cable spool 406 may be positioned such that the cable 418 passes through the slot 390 as the cable 418 is wound and unwound from the cable spool 406.

Referring FIG. 8 the trolley unit 364 of FIG. 6 with a portion of the second rail 354 is shown in a perspective view. The position actuator 332 may be at least partially enclosed by the trolley housing 366. The position actuator 332 may include the positioning motor 334 drivingly connected to the positioning gear 335 through gears 333. The positioning actuator 332 may be fixedly connected to the trolley housing 366. The positioning gear 335 may include gear teeth 372 which may mesh with the teeth 362 on the first rail bottom 351 and/or the second rail bottom 360. In the illustrated embodiment, when the positioning gear 335 rotates in a counter-clockwise direction as shown by the arrow marked “Counter Clockwise”, the trolley unit may move in the first direction as shown by the arrow marked “1^{st} Direction”. When the positioning gear 335 rotates in a clockwise direction as shown by the arrow marked “Clockwise”, the trolley unit may move in the second direction as shown by the arrow marked “2^{nd} Direction”. In the illustration of FIG. 8 the teeth 362 are a component of the second rail bottom 360, but in another embodiment the teeth 362 may alternatively, or in addition be a component of the first rail bottom 351. In the alternative embodiments, the positioning actuator including the positioning gear 335 may be mounted to the trolley housing 366 in a different location or orientation. In one embodiment (not shown), the positioning motor 334 may drive two positioning gears 335, one with gear teeth 371 meshing with teeth 362 on the second rail bottom 360, and the other with gear teeth 371 meshing with teeth 362 on the first rail bottom 351.

In another embodiment, the positioning actuator 332 may be positioned such that the positioning gear 335 meshes with a chain (not shown). One end of the chain may be connected to the trolley front 376 and the other end may be connected to the trolley rear 378 and form a loop which may be driven by the positioning gear 335.

Referring now to FIG. 9, the trolley unit 364 of FIG. 6 with a portion of the first rail 352 and the second rail 354 is shown in a top perspective view. The trolley housing 366 may at least partially enclose the positioning actuator 332, the hoisting power source 402, and the cable spool 406. The trolley housing 366 may also at least partially enclose components of a control system 500 which may control the direction and speed in which the lifting armature is lifted, lowered, moved in the first direction, and moved in a second direction. In the illustrated embodiment, the trolley housing 366 encloses a power supply 520, a positional receiver control 522, and a hoist receiver control 524. The power supply 520 may provide power to the positioning actuator 332 and/or the hoisting actuator 402.

The positional receiver control 522 may receive positioning commands from the user control device 502 and control the positioning actuator 332 in response to the positioning commands. The positioning commands may include a first direction move signal and/or a second direction move signal. The hoisting receiver control 524 may receive hoisting commands user control device 502 and control the hoisting actuator 402 in response to the hoisting commands. The hoisting commands may include a lift signal and/or a lower signal.

Referring now to FIG. 10A, a block diagram of an exemplary embodiment of the control system 500 for use with the windshield removal and replacement system 100 of FIG. 1 is illustrated. The control system 500 may include a user control device 502, an actuator control device 538, and a power supply 520. The user control device 502 may be a handheld device configured to detachably connect to the control handle assembly 200. In one embodiment, the handheld device may be similar to a key fob. A user may control the system 100 while gripping one or more control handle assemblies 200 with the user control device 502 connected to the control handle assembly 200. When the user control device 502 is not connected to the control handle assembly 200, the user may control the system 100 while located away from one of the control handle assemblies 200. For example, the user may be seated in the front seat of the vehicle 600, and may be cutting a urethane bead attaching a damaged windshield 602 from the vehicle 600. In another embodiment, the user control device 502 may be incorporated in and be an integral portion of the control handle assembly 200. In some embodiments, one user control device 502 may be a single handheld unit, and another user control device 502 may be incorporated into the control handle assembly 200. The user control device 502 may also be a single electronic device, or software and hardware incorporated into an electronic device such as a phone, an electronic tablet, and/or a laptop, personal, or other computer.

The user control device 502 may include a user interface 504 which may allow the user to lift and lower the lift armature 102; move the lift armature 102 in the first direction and the second direction; and lift and lower the second crane member 324. The user interface 504 may include any user input devices 532, displays, and other features through which the user may interact with the control system 500 and system 100. The user interface 504 may include a hoisting interface 506 through which the user may interface with the hoisting system 400, and a positioning interface 512 through which the user may interface with the positioning system 300. In embodiments of the system 100 including a crane arm 320, the user interface 504 may include a crane arm interface 540 through which the user may interface with the crane actuator 336 and thus the crane arm 320.

The hoisting interface 506 may include a hoisting directional interface 508, and a hoisting speed interface 510. The hoisting directional interface 508 may include one or more user interface devices 532 through which a user may enter a lift command and/or a lower command, when the user desires to lift or lower (respectively) the lifting armature 102. For example the hoisting directional interface 508 may include two buttons 534. The hoisting directional interface 508 may be configured to generate a lift signal when a lift command is entered, and a lower signal when a lower command is entered. The hoisting speed interface 510 may include one or more user interface devices 532 through which a user may enter a hoisting speed command indicative of the speed at which the user desires to lift or lower the lifting armature 102. The hoisting speed interface 510 may be configured to generate a hoisting speed signal when a hoisting speed command is entered, and/or may modify a lift signal or a lower signal to include a desired hoisting speed.

The positioning interface 512 may include a positioning directional interface 514, and a positioning speed interface 516. The positioning directional interface 514 may include one or more user interface devices 532 through which a user may enter a first direction command and/or a second direction command, when the user desires to move the lifting armature 102 in a first direction or a second direction. For example the positioning directional interface 514 may include two buttons 534. The positioning directional interface 514 may be configured to generate a first direction signal when a first direction command is entered, and a second direction signal when a second direction command is entered. The positioning speed interface 516 may include one or more user interface devices 532 through which a user may enter a positioning speed command indicative of the speed at which the user desires to move the lifting armature 102 in a first direction or a second direction. The positioning speed interface 512 may be configured to generate a positioning speed signal when a positioning speed command is entered, and/or may modify a first direction signal or a second direction signal to include a desired positioning speed.

The crane arm interface 540 may include a crane arm directional interface 542, and a crane arm speed interface 544. The crane arm directional interface 542 may include one or more user interface devices 532 through which a user may enter a crane arm lift command and/or a crane arm lower command, when the user desires to lift or lower the lifting armature 102 through moving the second crane member 324 in relation to the first crane member 322. For example, the crane arm directional interface 542 may allow a user to rotate the second crane 324 in relation to the first crane member 322. In one embodiment, the crane arm directional interface may include two buttons 534. The crane arm directional interface 542 may be configured to generate a crane arm lift signal when a crane arm lift command is entered, and a crane arm lower signal when a crane arm lower command is entered. The crane arm speed interface 544 may include one or more user interface devices 532 through which a user may enter a crane arm speed command indicative of the speed at which the user desires to move the lifting armature 102 in a first direction or a second direction. The crane arm speed interface 512 may be configured to generate a crane arm speed signal when a crane arm speed command is entered, and/or may modify a crane arm lift signal or a crane arm lower signal to include a desired crane arm speed.

In some embodiments the hoisting speed interface 510, the positioning speed interface 516, and the crane arm speed interface 544 may include a single user device 532, such as a dial 536. In these embodiments a speed command may be entered by the user through the single speed interface. The speed interface may be configured to control the speed of lifting, lowering, moving in a direction, and moving in a second direction the lifting armature 102; and control the speed at which the second crane member 324 may be moved in relation to the first crane member 322.

The user interface 504 may be communicatively connected to one or more actuator control devices 538 through a communication link 526. The communication link 526 may be a remote communication link such as an RF or Wi-Fi link, or the communication link 526 may be a hard link such as electric wire or optical cable. The one or more actuator control devices 538 may include a hoisting motor control and receiver 524, a positioning motor control and receiver 522, and/or a crane motor control and receiver 546. The communication link 526 may include one communication link 526 or multiple communication links 526. In one embodiment, the hoisting motor control and receiver 524 may be configured to receive lift signals, lower signals and hoisting speed signals from the hoisting interface 506; the positioning motor control and receiver 522 may be configured to receive first direction signals, second direction signals and positioning speed signals from the positioning interface 512; and/or the crane arm motor control and receiver 546 may be configured to receive crane arm lift signals, crane arm lower signals and crane arm speed signals from the crane arm interface 540.

One or more of the actuator control devices 538 may be operationally connected to one or more power supplies 520 through one or more operational links 528. The power supplies 520 may be selectively electrically connected to the hoisting actuator 403, the positioning actuator 332, and the crane arm actuator 336 through electrical links 530. The actuator control devices 538 may be configured to control the amount of power supplied from the power supplies 520 through the electrical links 530 to the hoisting actuator 403, the positioning actuator 332, and the crane arm actuator 336. The hoisting actuator 403 may include the hoisting motor 404. The amount and direction of the power the hoisting motor 404 receives from the power supply 520 may determine the direction and speed in which the cable spool is 406 turned. The positioning actuator 332 may include the positioning motor 334. The amount and direction of the power the positioning motor 334 receives from the power supply 520 may determine the direction and speed in which the extension arm 303 is extended or retracted, or the direction and speed in which the trolley unit 364 is moved. The amount and direction of the power the crane arm actuator receives from the power supply 520 may determine the direction and speed in which the second crane member 324 moves in relation to the first crane member 322.

Referring now to FIG. 10B a second embodiment of a user interface 504 is illustrated in a block diagram. In the second embodiment, the user interface 504 may be located on two separate user control devices. One user control device 520 may include the hoisting interface 506, the crane arm interface 540, and the positioning directional interface 514. The positioning speed interface 516 may be located on a user control device 502 located in the service vehicle 606.

### INDUSTRIAL APPLICABILITY

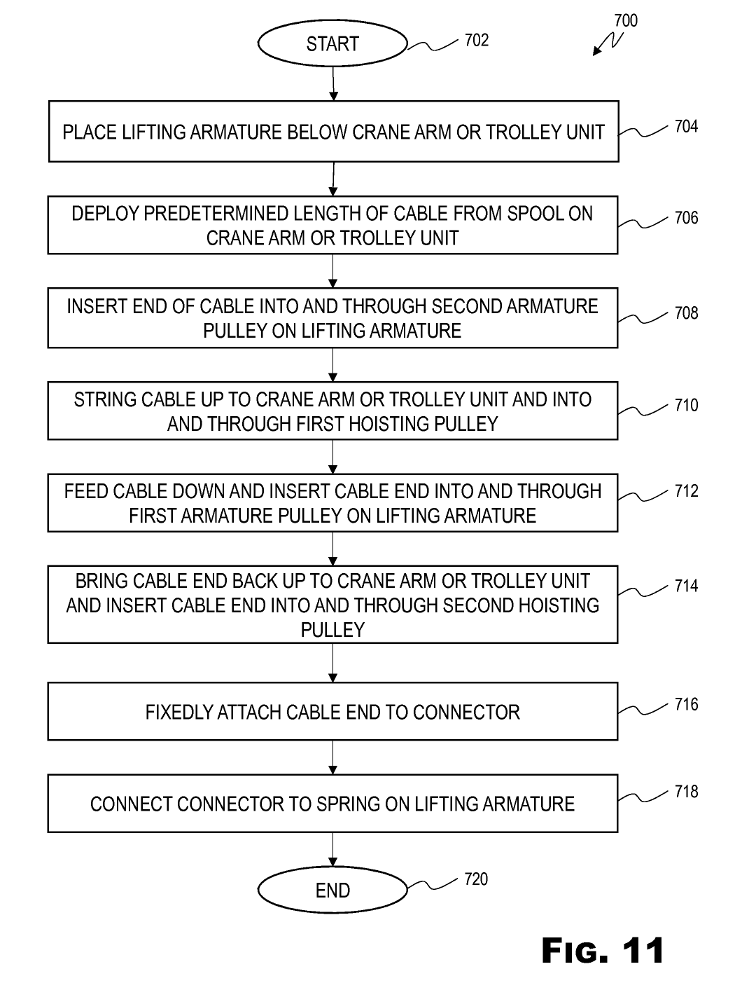

Referring now to FIG. 11 an exemplary method 700 to connect the lifting armature 102 of FIG. 2 to the positioning system 300 and the hoisting system 400 is illustrated in a flow chart. The method 700 starts at step 702. The lifting armature 102 may be placed below the crane arm 320 or the trolley unit 364 (step 704). This may be done by moving the lifting armature 102, extending or retracting the extension arm 303, and/or moving the trolley unit 364. A predetermined length (or range of length) of cable may be unwound from the cable spool 406 (step 706). The predetermined length may be, for example thirty feet, and/or in the range of twenty feet to forty feet.

The end of the length of cable 408 may be inserted into and through the first armature pulley 172 (step 708). The end of the cable 408 may then be inserted into and through the first hoisting pulley 410 (step 710). The end of the cable 408 may then be inserted into and through the first armature pulley 170 (step 712). The end of the cable 408 may then be brought up and inserted into and through the second hoisting pulley 412 (step 714). The end of the cable 408 may then be fixedly attached to first spring 164 (step 716). This may be done by attaching the end of the cable to a connector with a secure knot and attaching the connector to the first spring 164. It will be apparent to those skilled in the art that if the embodiment of the lifting armature 102 illustrated in FIG. 1 is being connected to the positioning system 300 and the hoisting system 400, the connector may alternatively be clipped to a connecting ring between the second spring 166 and the third spring 168. The method 700 ends at step 720.

Referring now to FIG. 12A, a first portion of an exemplary method 800 of removing the windshield 602 from the vehicle 600 is illustrated in a first portion of a flow chart. The method starts at step 802. The vehicle 600 may be positioned in relation to the system 100 such that the positioning system 300 and the hoisting system 400 can move the lifting armature 102 with the windshield 602 attached to it between the windshield frame 604 (shown in FIG. 13) and a windshield holding device. The windshield holding device may be placed in front of the vehicle 600 hood (step 804). The lifting armature 102 may be positioned over the windshield frame 604 (step 806). To accomplish this with a mobile gantry 304, the extension arm 303 may be extended or retracted, to move the lifting armature 102 in the first direction and/or the second direction using the positioning interface 512. To accomplish this with a stationary gantry 340, the trolley unit 364 may be moved in the first direction and/or the second direction using the positioning interface 512. The hoisting interface 506 may be used to lift and lower the lifting armature 102. To assure maximum suction pressure integrity of the vacuum lifter cups 120, the center of the windshield 602 may be cleaned (step 808). This may be done by spraying glass cleaner on the center of the windshield 602 and wiping/cleaning the windshield 602.

The hoisting interface 506 may be used to lower the lifting armature 102 so that the lifting devices 116 are on the windshield 602 (step 810). The lifting armature 102 may be lowered enough to provide some slack in the cable 408 such that the lifting devices 116 may be attached to the windshield 602. The lifting devices 116 may be attached to the windshield 602 with the attachment actuator 126 (812). The lifting devices 116 may be attached to the windshield 602 suction cups so the lifting armature 102 is roughly centered on the windshield 602, horizontally and vertically.

Referring now to FIG. 13, a portion of the vehicle 600 with the lifting armature 102 attached to the windshield 600 is illustrated.

Referring back to FIG. 12A, one or more control hand assemblies 200 may be attached to the windshield 602 by attaching the lifting devices 116 to the windshield 602 with the attachment actuator 126 (step 814). In one embodiment, two control handle assemblies 200 may be attached to the windshield 602 to the left or the right of the lifting armature 102.

The lifting armature 102 may be lifted with the hoisting interface 506 just enough to separate the coils of the first spring 164, the second spring 166, and/or the third spring 168 (step 816). In one embodiment the coils may be separated between two and three millimeters (2-3 mm) or approximately one eighth of an inch (⅛″). This may be done with a user control device 502 separate from the control handle assembly 200 such that the user may be inside the vehicle 600. The windshield 602 may be separated from the windshield frame 604 while the height of the lifting armature 102 is adjusted with the hoisting interface 506 (step 818). The windshield 602 may be separated from windshield frame 604 with a cutout tool that may slice a urethane bead holding the windshield 602 to windshield frame 604. As the bead is cut, the windshield 602 may show movement up and away from the windshield frame 604. A user may carefully adjust the height of the lifting armature 102 to ensure that too much pressure which will cause the windshield to crack and fold and/or to be over forcefully separated from the frame is not applied. Once the bead has been fully cut and the windshield 602 suspended just above the windshield frame 604, a user may grab the one or more control handle assemblies 200 and raise the windshield 600 (step 820). In one embodiment, the windshield 602 may be raised approximately six inches (6″).

Referring now to FIG. 12B, a second portion of the exemplary method 800 of removing the windshield 602 from the vehicle 600 is illustrated in a second portion of the flow chart. The windshield 602 may be rotated to a horizontal plane, roughly parallel with the vehicle's hood (step 822). The windshield 602 may be raised by lifting the lifting armature 102 with the hoisting interface 506 (step 824).

In one embodiment, the windshield 602 may be raised approximately another 6-12 inches. The windshield 602 may be raised to a height where movement will not hit the vehicle 600. By retracting the extension arm 303, or moving the trolley unit 364 through the positioning interface 512; and guiding the windshield 602 with the control handle assembly(s) 200; the windshield 602 may be moved over the windshield holding device (step 826). During this step caution may be used to ensure the windshield 602 does not contact vehicle 600.

The hoisting interface 506 may be used to lower the windshield 602 onto the windshield holding device (step 828). The lifting armature 102 and the control handle assembly(s) 200 may be detached from the windshield 602 by detaching the lifting devices 116 with the attachment actuators 126 (step 830). The lifting armature 102 may be lifted and/or moved in the first direction or the second direction such that the lifting armature 102 does not interfere with movement of people or objects with the hoisting interface 506 (step 832). The windshield 602 may be moved to a place for later disposal, for example in the service vehicle 606 (step 834). The method 800 ends at step 836.

Referring now to FIG. 14A, a first portion of an exemplary method 900 of replacing the windshield 602 on the vehicle 600 is illustrated in a first portion of a flow chart. The method starts at step 902. The windshield installer may put clean and oil free gloves on his/her hands before handling a replacement windshield 608 (shown in FIG. 15) (step 904). The replacement windshield 608 may be removed from the service vehicle 606, or other place (for example shop storage area), and placed on the windshield holding device with the outside face of the replacement windshield 608 down (step 906). The inside surface of the replacement windshield 608 may be cleaned, especially around the outside edges. Once cleaned, the replacement windshield 608 may be flipped such that the top of the replacement windshield 608 faces the hood of the vehicle 600 being serviced (step 908). A urethane bead may be extruded around the perimeter of the vehicle frame 604 assuring all joints are paddled in for a continuous sealed bead (step 910).

The portion of the replacement windshield 608 to which the attachment devices 116 of the lifting armature 102 and control handle assembly(s) may attach may be cleaned (step 912). This may be accomplished by spraying a thin layer of windshield cleaner on the center top portion of the replacement windshield 608, and wiping/cleaning it the cleaner off. One or more control handle assembly(s) 200 may be attached on one side of the replacement windshield 608 (step 914). In one embodiment, two control handle assemblies 200 may be attached. The control hand assembly(s) may be attached with the attachment actuators 126.

The lifting armature 102 may be lowered using the hoisting interface 506 such that the lifting devices 116 are on the replacement windshield 608 surface (step 916). In one embodiment, the lifting devices 116 may be placed on the replacement windshield 608 such that the two lifting devices 116 attached to the lateral frame member 112 are approximately two inches from the top of the replacement windshield 608 and approximately centered using the rear view mirror attachment as a guide. Measurement may not be required to place the lifting devices 116 in this position, just close approximation. The lifting armature 102 may be attached to the replacement windshield 608 with the attachment actuators 126 (step 918). The replacement windshield 608 may be raised using the hoisting interface 506 while the control handle assembly(s) 200 are used to guide the replacement windshield 608 (step 920). The replacement windshield 608 may be maintained in a horizontal orientation to the vehicle 600 hood and raised approximately eighteen inches (18″) above the vehicle 600 hood. The control handle assembly(s) 200 may be used to manually control and stabilize the replacement windshield 608.

Referring now to FIG. 15, a perspective view of the system 100 with the lifting armature 102 connected to the replacement windshield 608 is illustrated.

Referring now to FIG. 14B, a second portion of the exemplary method 900 of replacing the windshield 602 on the vehicle 600 is illustrated in a second portion of the flow chart. The replacement windshield 608 may be moved such that the center of the windshield is approximately over the center of the windshield frame 604 (step 922). This may be done by extending the extension arm 303 on the mobile gantry 304, or moving the trolley unit 364 on the stationary gantry 340. The positioning interface 512 may be used to accomplish this. The control handle assembly(s) 200 may be used to manually tilt the replacement windshield 608 such that the replacement windshield 608 is in a plane approximately parallel to that of the windshield frame 604 (step 924). The replacement windshield 608 may be lowered to about six to nine incher (6″-9″) above the windshield frame using the hoisting interface 506 (step 926).

The hoisting speed interface 510 may be used along with the hoisting directional interface 508 to slowly set the replacement windshield 608 in the windshield frame 604 such that the replacement windshield 608 fits exactly within the windshield frame 604 (step 928). The system 100 may allow for top, side or bottom sets on the windshield frame 604 according to the vehicle 600 and installer preference. The set of the replacement windshield 608 into the windshield frame 604 may be checked, and any fine adjustments made (step 930). The springs 160 may allow for fine movement of the replacement windshield 608 while the lifting armature 102 keeps the replacement windshield 608 in place. The lifting armature 102 may be detached from the replacement windshield 608 with the attachment actuators 126 and lifted out of the way with the hoisting interface 506 (step 932). The replacement windshield 608 may be pressed fully into the urethane bed (step 934). The method 900 may end at step 936.

It should be understood, of course, that the foregoing relates to exemplary embodiments of the invention and that modifications may be made without departing from the spirit and scope of the invention as set forth in the following claims.

We claim:

1. A lift armature for lifting a windshield when removing the windshield from or replacing the windshield in a vehicle, comprising:
an armature frame;
multiple lifting devices pivotally connected to the armature frame and configured to detachably connect to the surface of the windshield; and
at least one hoisting device pivotally connected to the armature frame.

2. The lift armature of claim 1, wherein the armature frame further comprises:
a longitudinal frame member with a first longitudinal end, a second longitudinal end, a top longitudinal side, and a bottom longitudinal side; and
a lateral frame member with a first lateral end, a second lateral end, a top lateral side, and a bottom lateral side; the lateral frame member connected to the second longitudinal end of the longitudinal frame piece.

3. The lift armature of claim 1, wherein the multiple lifting devices comprise:
a first vacuum lifter pivotally connected to the first longitudinal end, on the bottom longitudinal side, of the longitudinal frame piece;
a second vacuum lifter pivotally connected to the first lateral end, on the lateral bottom side of the lateral frame member; and
a third vacuum lifter pivotally connected to the second lateral end, on the lateral bottom side of the lateral frame member.

4. The lift armature of claim 1, wherein the at least one hoisting device comprises:
a first spring connected to the longitudinal top side of the longitudinal member;
a second spring connected to the first lateral end, on the lateral top side, of the lateral member;
a third spring connected to the second lateral end, on the lateral top side, of the lateral member;
a first armature pulley connected to the longitudinal top side of the longitudinal member; and
a second armature pulley connected to at least one of the first spring and the second spring.

5. A windshield removal and replacement system, comprising:
the lift armature of claim 1;
a hoisting system comprising a hoisting mechanism, and a hoisting power source connected to drive the hoisting mechanism, the hoisting mechanism configured to connect to each of the hoisting devices, the hoisting mechanism configured to lift the lift armature in response to a lift signal, and lower the lift armature in response to a lower signal when connected to each of the hoisting devices;
a user control device with an user interface, the user interface comprising a user hoisting interface configured to generate the lift signal and the lower signal.

6. The windshield removal and replacement system of claim 5, wherein:
the hoisting power source comprises a hoisting motor;
the hoisting mechanism comprises a cable spool connected to the hoisting motor to be rotatably driven by the hoisting motor, a first hoisting pulley, a second hoisting pulley, and a cable connected to the cable spool to be wound and unwound from the spool, the cable configured to be wound through the first hoisting pulley and the second hoisting pulley;
the hoisting motor rotatably drives the cable spool in a first rotation direction to wind the cable on the cable spool in response to the lift signal; and
the hoisting motor rotatably drives the cable spool in a second rotation direction to unwind the cable from the cable spool in response to the lower signal, the second rotation direction opposite the first rotation direction.

7. The windshield removal and replacement system of claim 5, further comprising a mobile gantry, the mobile gantry comprising:
a first guide bar;
a second guide bar;
an extension arm assembly slidingly connected between the first guide bar and the second guide bar, the extension bar assembly comprising an extension arm having an extension arm first end, an extension arm second end, an extension arm top, and an extension arm bottom; and
a positioning actuator connected to the extension arm to extend and retract the extension arm first end from between the first guide bar and the second guide bar; and
wherein the hoisting mechanism is fixedly mounted on the extension bar assembly; and
wherein the lift armature is moved in a first direction when the extension arm is extended and in a second direction when the extension arm is retracted.

8. The windshield removal and replacement system of claim 7, wherein the extension arm assembly further comprises:
a crane arm, including a first crane member and a second crane member, the first crane member fixedly connect to and generally perpendicular to the extension arm, the second crane member pivotally connected to the first crane member; and
a crane actuator connected to the second crane member and the extension arm, and operable to raise and lower the second crane member; and
wherein the hoisting mechanism is fixedly mounted on the second crane member.

9. The windshield removal and replacement system of claim 7, further comprising:
a roller assembly comprising guide rollers rotatably connected to a roller connector assembly, the roller connector assembly fixedly connected to the extension arm at the extension arm second end; and
wherein the first guide bar comprises a first roller track;
wherein the second guide bar comprises a second roller track; and
wherein the guide rollers are disposed to roll in the first roller track and the second roller track when the extension arm is extended and retracted.

10. The windshield removal and replacement system of claim 5, further comprising:
a stationary gantry comprising;
a first rail; and
a second rail;
a trolley unit positioned between, supported by, and configured to move between the first rail and the second rail; and
a positioning actuator drivingly connected to the trolley unit, and configured to drive the trolley unit in a first direction and a second direction, between the first rail and the second rail; and
wherein the hoisting mechanism is fixedly mounted on the trolley unit; and
wherein the lift armature is moved in the first direction when the trolley unit moves in the first direction, and in the second direction when the trolley unit moves in the second direction.

11. The windshield removal and replacement system of claim 10, wherein:
the trolley unit comprises a trolley frame, a trolley top, a trolley front, a trolley rear, a trolley first side, a trolley second side, and rollers; the rollers rotatably connected to the trolley frame on the trolley first side and the trolley second side at the trolley top;
the first rail comprises a first rail top with a first roller track;
the second rail comprises a second rail top with a second roller track; and
the rollers are disposed to roll in at least one of the first roller track and the second roller track when the trolley unit moves in the first direction or the second direction.

12. The windshield removal and replacement system of claim 10, wherein:
the trolley unit comprises a trolley frame;
the first rail comprises a first rail bottom
the second rail comprises a second rail bottom;
at least one of the first rail bottom and the second rail bottom comprises teeth;
the position actuator is fixedly connected to the trolley frame and comprises a positioning motor drivingly connected to a positioning gear; and
the positioning gear is drivingly engaged with the teeth to move the trolley unit in the first direction and the second direction.

13. The windshield removal and replacement system of claim 5, further comprising:
a control handle assembly, comprising;
a handle;
a lifting device fixedly connected to the handle, and configured to detachably connect to the windshield; and
a user control device mount; and
a control device attachment device configured to detachably connect the user control device to the user control device mount.

14. The windshield removal and replacement system of claim 7, wherein:
the user interface further comprises a user positioning interface configured to generate a first directional signal and a second directional signal; and
the positioning actuator is configured to retract the extension arm first end in response to the first directional signal, and extend the extension arm first end in response to the second directional signal.

15. The windshield removal and replacement system of claim 10, wherein:
the user interface further comprises a user positioning interface configured to generate a first directional signal and a second directional signal; and
the positioning actuator is configured to drive the trolley unit in the first direction in response to the first directional signal, and drive the trolley unit in the second direction in response to the second directional signal.

16. A vehicle windshield removal method, comprising:
connecting at least one lifting device of a lifting armature to the windshield while the windshield installed in the windshield frame of a vehicle;
connecting a hoisting system to one or more hoisting devices of the lifting armature;
detaching the windshield from the windshield frame;
inputting a lift command with an user control device to generate a lift signal;
providing power to the hoisting system with a power source in response to the lift signal;
lifting the windshield out of the windshield frame with the lifting armature and hoisting system.

17. The windshield removal method of claim 16, further comprising:
inputting a first directional command with an user control device to generate a first directional signal;
providing power to a positioning system with a power source in response to the first directional signal; and
moving the lifting armature in a first direction with the positioning system.

18. The windshield removal method of claim 16, further comprising:
connecting a lifting device of a control hand assembly to the windshield;
connecting the user control device to the control handle assembly; and
grasping a handle of the control handle assembly and guiding the windshield with the control handle assembly.

19. A vehicle windshield replacement method, comprising:
applying a urethane bead around the perimeter of an empty vehicle windshield frame;
connecting at least one lifting device of a lifting armature to a new replacement windshield;
connecting a hoisting system to one or more hoisting devices of the lifting armature;
inputting a lift command with an user control device to generate a lift signal;
providing power to the hoisting system with a power source in response to the lift signal;
lifting the replacement windshield with the lifting armature and hoisting system;
moving the replacement windshield over the windshield frame with the lifting armature and a positioning system;
inputting a lower command with the user control device to generate a lower signal;
providing power to the hoisting system with the power source in response to the lower signal; and
lowering the replacement windshield into the windshield frame and onto the bead with the lifting armature and hoisting system.

20. The vehicle windshield replacement method of claim 18, further comprising:
connecting a lifting device of a control hand assembly to the windshield;
connecting the user control device to the control handle assembly; and
grasping a handle of the control handle assembly and guiding the windshield with the control handle assembly.
